(19) United States
(12) Patent Application Publication
(10) Pub. No.: US 2009/0006224 A1
(43) Pub. Date: Jan. 1, 2009

(54) Control System Method for Internet Communication

(76) Inventor: Kwang-Ik Kim, Seoul (KR)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 11/718,502

(22) PCT Filed: Nov. 18, 2004
(86) PCT No.: PCT/KR04/02986

§ 371 Date: May 22, 2008

(51) Int. Cl. G06Q 10/00; G06F 15/16; G06F 17/30; G06Q 30/00

(52) U.S. Cl. 705/30; 709/202; 707/100; 705/1; 707/E17.044

(57) ABSTRACT

The present invention relates to a system that enables an Internet call between a provider and a customer by using the Internet, and particularly, to an Internet call controlling system and a method thereof for making a call between the customer and the corresponding provider over the Internet or with the use of a PSTN free of charge through an execution of a click program associated with an icon once the customer clicks the icon, by comprising the click program associated with the icon capable of conducting free calls on a web page or e-mail of the provider or a web page of a system operator, and for enabling the provider to more closely manage the customer by recognizing received customer information.

### FIELD OF THE INVENTION

The present invention generally relates to a controlling system for Internet calls, which can communicate with a personal computer or general calls over the Internet, and a method thereof, and more specifically, to an Internet call controlling system and a method thereof for accessing the Internet or making general calls free of charge by clicking a particular indication (icon, product screen, etc.) associated with receiver information without inputting all of the receiver information on a sender PC, in case a sender does not know the receiver's ID or the Internet telephone number, or even knows it.

### BACKGROUND OF THE INVENTION

Recently, as the Internet is being rapidly applied in various fields, interest for using the Internet phone which can save telephone charges is growing. Thus, a lot of controlling technology has been developed in various ways.

However, technologies suggested so far have several problems that the sender should examine all of the information on the other party desired for call and individually input the examined information. In this case, both sender and receiver should join a service provider which supplies such a service.

In addition, if an Internet provider wants to make a call with an unspecified person instead of a specific one, it is very difficult to make the call by using the above method, resulting in inapplicability to the business.

To solve these problems, click-type Internet call controlling technology capable of making calls with unspecified persons has been suggested, including other various methods.

That is, when a particular provider (ex, Internet shopping mall) posts a product advertisement on the web page of his company for business activities over the Internet, the provider may insert a specific indication such as the sending icon at the same time, so that the unspecified general customer can immediately make an Internet call by clicking the specific indication in order to directly call the shopping mall provider by seeing the product advertisement.

Certainly, there is a method of sending the specific indication together with e-mail, in order that the unspecified e-mail receiver can make an instant Internet call with the provider by clicking the specific indication displayed on the screen after opening the received e-mail.

However, in case of the above method, the specific indication clicked by the sender is simply linked with a call processing server having information on the receiver (provider), and it is a simple relaying method so that a call can be made over the Internet between the sender and the provider with which the call processing server is linked through a clicking signal of the sender.

Thus, since the call is controlled through the simple link, information such as an ID of the sender (customer) cannot be provided, even though the particular receiver (provider) obtains customers for his business purpose.

In other words, because the customer who has called at least once tends to be more interested in the business field of the called provider, compared to the general customers, it is desirable to obtain the customer as a long-term customer by continuously managing the customer and offering e-mail including advertisement. But, the prior art cannot recognize the sending information on customers, making customer management unavailable.

Furthermore, if the Internet call should be connected to a PSTN, the service provider has to pay various charges for the collective gateways. And, one-to-one fixed access calling method with which the user individually uses line adapters has a problem that there exists no call forwarding function required to make calls with many receivers and senders

Once, there was an attempt for the provider (receiver) to directly draw up a particular indication with a click program and to provide the sender's ID to a receiving side, but because the call processing server which associates the ID with an IP should be operated, it is hard for the general provider (receiver) to substantially provide such a function alone, and when the receiver directly writes the click program, it is difficult to use it owing to complicated operations and the need for professional knowledge.

### SUMMARY OF THE INVENTION

It is therefore an object of the present invention to provide a click-type Internet call controlling system and a method thereof for a provider, who wants to call unspecified persons with an Internet phone on the Internet, to include receiver information like a self ID and a telephone number provided by being automatically generated by a system operator, in a web page or advertising mail, and to allow a click program executed in association with a particular indication (icon) to be written in a customer PC which is the user, so that a call message containing the sender's ID can be delivered to a call processing server once the customer (sender) clicks the particular indication, to make a call to the provider free of charge over the Internet while at the same time, the provider (receiver) can recognize information (ID) of the customer (sender).

It is another object of the present invention to provide a clicking-type Internet call controlling system and a method thereof for the provider to always offer business publications or advertisements to the senders (customers) as e-mail with the use of statistically processed sender information by recognizing the sender information and accumulating/processing the recognized sender information, thereby more closely managing particular customers among the unspecified customers.

It is another object of the present invention to provide clicking-type Internet call controlling system and a method thereof for making a free call with a particular provider on the Internet when necessary, by automatically accumulating call details on the interested provider at the customer (sender) PC to use the accumulated information at any time.

It is another object of the present invention to provide an Internet call controlling system and a method thereof for enabling the system service provider (operator) who services the above system to accumulate information on members (being provided with user agents having reception/sending functions) who join in the system service and to provide the accumulated information to a web server of the system operator, so that the members joining in the Internet call controlling system service of the present invention can make Internet calls among them, thereby offering business effects for the provider while general members can call other members in convenient way.

It is another object of the present invention to provide an Internet call controlling system and a method thereof for allowing to call a desired party once the desired party clicks an icon only if a random member wants to call the desired party, when the random member sends e-mail by inserting the icon into the e-mail after receiving authentication of the system operator.

Furthermore, it is another object of the present invention to provide an Internet call controlling system and a method thereof associated with an easy-to-use and relatively inexpensive wire/wireless phone, by assigning a function, through which the sender or the receiver can individually send or receive a call with a general wire/wireless phone, to the Internet call controlling system that a lot of users frequently use at the same time without any restriction.

To achieve the above objects of the present invention, an Internet call controlling system in accordance with the present invention,

the Internet call controlling system using the Internet, comprising:

a DB server for storing information on joined members;

a web server of a provider for containing a click program that delivers unique information including a provider's ID to a user agent having a sending function once an icon is clicked, and for including a web page on which the icon is displayed;

a customer PC for containing a user agent having a sending function of delivering the unique information, which includes the ID of the provider delivered by the click program, as a paging signal together with a customer ID, once the icon is clicked;

a call processing server configured to inquire about an IP address of a provider PC stored in the DB server, by receiving the paging signal; and

a user agent having a receiving function of storing the customer ID by receiving the paging signal and connecting the call with the customer PC.

Also, an Internet call controlling system in accordance with the present invention,

the Internet call controlling system using the Internet, comprising:

a DB server for storing information on joined members;

a member management server having a click program which senses that an icon is clicked and delivers unique information of a provider to a user agent having a sending function;

an e-mail server for storing the provider's e-mail in which the icon is displayed;

a customer PC having a user agent that delivers the provider's unique information delivered by the click program, as a paging signal together with a customer ID, once the icon is clicked;

a call processing server configured to inquire about an IP address of a provider PC stored in the DB server, by receiving the paging signal; and

the provider PC comprising a user agent having a receiving function of storing the customer ID by receiving the paging signal and connecting the call with the customer PC.

Moreover, an Internet call controlling system in accordance with the present invention,

the Internet call controlling system using the Internet, comprising:

a DB server for storing provider information;

a provider information processor for searching provider information corresponding to a search keyword inputted from a customer PC in the DB server, and providing the searched provider information to an icon generator for generating a click program which delivers unique information including IDs of each provider to a user agent having a sending function, once an icon associated with the unique information is clicked;

a member management server having the web server of a system operator, being equipped with the provider information and the click program in a predetermined location, by receiving the information and the program from the provider information processor and associating the received information and the program with the icon, respectively;

a customer PC for containing a user agent having a sending function of delivering the provider's unique information delivered by the associated click program, as a paging signal together with a customer ID, once the icon is clicked;

a call processing server configured to inquire about an IP address of a provider PC stored in the DB server, by receiving the paging signal; and

the provider PC for containing a user agent having a receiving function of storing the customer ID by receiving the paging signal and connecting the call with the customer PC.

Likewise, an Internet call controlling system in accordance with the present invention,

the Internet call controlling system using the Internet, comprising:

an e-mail server for storing e-mails of members;

a DB server for storing information on the members;

a member management server for inputting the information on the members to store the inputted information in the DB server, and performing a function required for member management;

a sending PC containing a user agent having a sending function of delivering an inputted telephone number to a call processing server as a paging signal by a sending button;

the call processing server for inquiring about an IP position of a receiving PC stored in the DB server, by receiving the paging signal, and relaying the paging signal to the receiving PC; and

the receiving PC containing a user agent having a receiving function of receiving the paging signal of the call processing server, delivering a response signal, and making a call; and wherein

individual line adapters connected to a PSTN are coupled with the receiving PC or the sending PC, and the receiving and sending user agents additionally have a function of controlling an Internet call with a general telephone through the receiving/sending PCs and the line adapters connected to the PSTN; and wherein

the receiving and sending user agents can receive and send Internet calls by recognizing and relaying signals or data of the PCs with the general telephone connected to the PSTN.

Besides, an Internet call controlling method in accordance with the present invention, in the Internet call controlling method using the Internet, comprising the steps of:

delivering information including the provider's ID by a click program associated with an icon clicked and comprised in a provider web server when a customer clicks the icon displayed in the provider web server;

a user agent having a sending function, which is installed in a customer PC, receiving unique information including the provider's ID, and delivering the unique information as a paging signal together with a customer ID;

when the paging signal is received, inquiring about an IP address of a provider pc corresponding to the provider's ID included in the paging signal from a DB server where the provider's information is stored, by the call processing server, and delivering the paging signal together with the customer ID to the inquired IP address; and

when the provider PC receives the paging signal, delivering a response message to a customer PC by a user agent having a receiving function.

And, an Internet call controlling method in accordance with the present invention, in the Internet call controlling method using the Internet, comprising the steps of: when a provider inputs the text of e-mail and a customer ID in a member management server and clicks a send button, an icon generator, extracting unique information containing the provider's ID from a DB server, and generating a click program for delivering the unique information containing the provider's ID associated with an icon to a user agent, once the icon is clicked, then inserting the generated program into the e-mail to send the e-mail to a customer's e-mail server;

a customer PC, delivering the unique information including the provider's ID as a paging signal together with an ID of a customer PC by a user agent having a receiving function, when a displayed icon is clicked by receiving the e-mail from the e-mail server;

when the paging signal is received, inquiring about an IP address of a provider PC corresponding to the provider's ID included in the paging signal from the DB server where provider information is stored, by a call processing server, and delivering the paging signal together with the customer ID to the inquired IP address; and

the provider PC, delivering a response message to the customer PC by a user agent having a receiving function, if the paging signal is received.

In addition, an Internet call controlling method in accordance with the present invention, the Internet call controlling method using the Internet, comprising the steps of:

delivering information containing a provider ID by a click program comprised in a web server of a system operator and associated with a clicked icon, if a customer clicks the particular one of plural icons displayed in the web server of the system operator;

a user agent having a sending function, which is installed in the customer PC, receiving the provider's information, and delivering the paging signal together with the customer ID;

when the paging signal is received, inquiring about an IP address of a provider PC corresponding to the provider ID included in the paging signal from a DB server where the provider information is stored, by the call processing server, and delivering the paging signal together with the customer ID to the inquired IP address; and

the provider PC, delivering a response message to the customer PC by a user agent having a receiving function, if the paging signal is received.

Furthermore, an Internet call controlling method in accordance with the present invention, the Internet call controlling method using the Internet, comprising the steps of:

a member management server for managing information on members, storing the information on the members in a DB server;

when a sender clicks an icon displayed in a receiver's web server, delivering information including the receiver's ID by a click program associated with the icon clicked and comprised in the receiver's web server;

a user agent having a sending function, which is installed in a sending PC, receiving unique information including the receiver's ID, and delivering the received information as a paging signal together with a sender ID;

when the paging signal is received, inquiring about an IP address of a receiving PC corresponding to the receiver's ID included in the paging signal from a DB server where the receiver's information is stored, by a call processing server, and delivering the paging signal together with the sender ID to the inquired IP address;

the receiving PC, delivering a response message by a user agent having a receiving function, by receiving the paging signal, and carrying out a call function; and wherein

the receiving or the sending PC, comprising the steps of: reading a sending number through a DTMF transceiver if a sending signal of a telephone is sensed in individual line adapters connected to a PSTN;

when the sending signal is detected, delivering the paging signal to the call processing server through an SIP processor by the user agent; and

being on standby by unconditionally connecting a sound input/output path with the PSTN through the line adapters according to a set mode or connecting with the receiving PC, and connecting the paging signal received in the PC to the PSTN after a certain time elapses.

The Internet call controlling system in accordance with the present invention will be described as follows, and detailed explanations on functions or configurations in accordance with the related technology will be omitted if it is decided that the functions or the configurations may blur the purpose of the present invention.

The present invention enables call transmissions free of charge by using the system in accordance with the present invention, if only all people (hereinafter, ‘customers’) are joined as members (in some cases, usable by only logging-in).

But, a receiving function is provided to a paid member (hereinafter, ‘provider’) only, and it is useful for a provider who carries on a business over the Internet or a person who wants a two-way call. In some cases, a system operator can selectively distinguish paid from free functions. That is, both provider and customers can receive a free service, or on the contrary, a paid service is applied to both of them, or the provider receives the free service while the customers use the paid service. Moreover, a variety of options for receiving/sending functions are available. The present invention is basically described as one standard, and if other cases of executions include basic notions of the present invention, they will be included in the same category. An internal PC block diagram of FIG. 2 shows the same configuration for sending and receiving, thus reference numerals 21 to 29 refer to a provider, while reference numerals 31 to 39 correspond to a customer. User agents (21)(31) comprise receiving/sending functions, respectively, however, a separate recognition code is assigned to an ID of the provider, and is stored in a DB server (11) such that a call processing server (12) can decide whether the ID is a receivable ID. Accordingly, the customer cannot conduct the receiving function. But, when necessary, it is available to separately configure the receiving and sending functions, without distinguishing IDs. However, in this case, inefficiency of the call processing server (12) may be produced like shown below.

First, a first embodiment (using a provider web) of the present invention in accordance with FIG. 1 through FIG. 3 will be mainly described as follows.

The DB server (11) stores member information (IDs, firm names, names, telephone numbers, addresses, web page addresses, passwords, etc.), and at this time, receivable provider IDs are distinguished.

A member management server (1) is equipped with an icon generator (13) comprised to generate a click dial program (hereinafter, ‘click program’) that selectively extracts necessary information from the provider information stored in the DB server (11), encodes the extracted information, respectively, and decodes the associated encoded information when a specific indication (hereinafter, ‘icon’) is clicked.

A web server (4) installs the click program in a predetermined position within a web page of the provider, and supplies the click program to a customer PC (3).

The customer PC (3) has a user agent program (hereinafter, ‘sending user agent’) that derives the stored information (ID, telephone number, firm name, web page address, validity period, selective item) of the provider decoded by the click program executed by clicking the icon displayed in the provider web server (4), delivers the derived information together with a customer ID to the call processing server (12) as a paging signal, and conducts an Internet call function according to a response signal of a provider PC (2).

The call processing server (12) inquires about whether a sender (customer) is joined as a member and logs in, by recognizing the call paging signal delivered from the customer PC (3), from the DB server (11), retrieves an IP position of the provider PC (2) corresponding to a provider ID stored while the provider logs in, from the DB server (11) if the sender is a login member, and relays the call paging signal containing an ID of the sender (customer) PC (3) to the provider PC (2).

The provider PC (2) has a receiving user agent program (hereinafter, ‘receiving user agent’) that delivers a response signal to the customer PC (3) if the call paging signal is received from the call processing server (12) and executes an Internet call function.

Basically, the above receiving/sending user agents (21)(31) are separately equipped in the member management server (1) together with the icon generator (13) comprised to generate the click program by encoding necessary items when the provider joins, and are configured in the click program to install each of demanded user agents in the PCs (2)(3) by clicking the corresponding icon of the member management server (2).

The provider web server (4) includes all web servers where icons are posted, as well as a web server directly operated by the provider, and the customer can install the user agents by clicking the icon displayed in the web server (4) of the provider.

At this point, the customer and the provider should previously log in, in order that the call processing server (12) can recognize each ID and IP addresses of the PCs (2)(3). Otherwise, the call processing server (12) cannot relay the paging signal.

Also, if the inquiry about IDs or IPs is not effective because all of the member information are stored in the DB server (11), it is possible to separately store information corresponding to the recognized IDs during login, in a temporary memory within the call processing server.

Besides, since the call processing server (12) cannot perceive whether a receiver ID delivered from the customer PC (3) is authenticated by the member management server (1), the server (12) once relays the paging signal by searching for an IP address of a receiver PC. But, in this case, if a user agent installed in the receiver PC does not have a receiving function, a call reception is impossible. Therefore, the call processing server (12) may conduct an unnecessary operation, resulting in deterioration of overall system efficiency.

So, it is desirable to have both receiving and sending functions of the user agents, thereby unifying into an integrated user agent capable of conducting the receiving and sending functions, while assigning a code for distinguishing the functions to an ID of the provider given with a receiving function to store the code in the DB server (11), and letting the DB server (11) inquire about whether a receiver ID is authenticated for reception when the call processing server (12) relays the call paging signal, so it is possible that the signal is not relayed if the inquired ID is not authenticated.

On this occasion, either the provider or the customer can install, free of charge with no strings attached, the user agents having the receiving and sending functions by only clicking the icon on the web server (4) of the provider or the system operator or the received e-mail where the icon is posted. But, only a PC having an ID authenticated by the system operator can conduct a reception function. If the reception function is not limited, it is available not to use a receivable recognition code of the DB server (11).

From now on, the invention will be described on the basis of the integrated user agent method.

As for the encoded member information items, it is available to select essential items (telephone number, ID) required for automatic transmission to the provider and optional items such as a firm name to be provided to the customer, or a web address of the provider for posting an icon or an authenticated validity period, which are required for the system operator.

Together with the above main configurations, the provider PC (2) and the customer PC (3) are equipped with e-mail browsers (22)(32) and web browsers (27)(37) of general PCs, respectively, and have transmitting/receiving apparatuses such as headsets, microphones, keyboards, and computer mice for Internet calls through user interfaces (25)(35). And, user agents (21)(31) disposed in the PCs (2)(3) have all receiving/sending functions necessary for the Internet calls in accordance with the present invention, as well as functions of controlling line adapters (6) connected to use a general telephone, and comprises signal (24)(34) for sending/receiving a paging message to/from controllers (28)(38) that control all functions, media processors (23)(33) having data conversion functions essential for the Internet calls, buddy list DBs (26)(36) for storing information on called parties, line adapter controllers (29)(39) for controlling the line adapters (6), and user/sound input/output units.

Each of the line adapters (6) is composed of a DTMF transceiver (61) for transceiving a general telephone dial signal, a directly coupled telephone connector (62) directly connected to a general telephone for conducting receiving/sending functions by using a headset of a pc, and a telephone network connector (63) connected to a PSTN, then is controlled by the line adapter controllers (29)(39).

In the present embodiment, if the provider tries to apply the present embodiment to plural products in a web server (hereinafter, ‘multi-subscription’), for instance, if an Internet shopping mall provider wants to receive each clicking-type Internet call service for many products, the member management server (1) separately conducts member registrations according to each necessary product, receives click programs containing each separate encoding information from the icon generator (13), respectively, and disposes the click programs in predetermined positions within web page programs of the Internet shopping mall provider.

That is to say, if the customer connects to the web server (4) of the shopping mall provider and clicks any one of icons for displayed products, the service in accordance with the present invention can be supplied to the customer by the corresponding click programs disposed in the web server (4) of the provider. To be sure, the same provider ID can be usable for each icon.

Next, a second embodiment (using e-mail) of the present invention in accordance with FIG. 1 through FIG. 3 will be described as follows.

All of the icon generator (13), the customer PC (3), the provider PC (2), the line adapters (6), the call processing server (12), and the DB server (11) of the first embodiment have the same functions and configurations, excluding the provider web server (4).

A member management server (1) has an e-mail delivery server (14) that inserts the click program arranged in the icon generator (13) into e-mail sent to the customer PC (3) by the provider with the use of the member management server (1) and delivers the e-mail to an e-mail server (5), so that the customer can make an Internet call with the provider PC (2) by clicking a displayed icon provided from the e-mail server (5) after seeing the customer's e-mail.

Namely, instead of displaying the icon through the web server (4) of the provider like the first embodiment, the second embodiment is different from the first one in terms of functions and configurations of displaying the icon on the e-mail sent to the customer.

Referring to FIG. 7, a process of delivering e-mail by the e-mail delivery processor (14) will be described in detail as follows. If the provider logs in with an ID and a password by accessing the member management server (1), the member management server (1) displays the number of allowable mails previously applied to the provider on a screen, counts the number of the mails when a delivery button is clicked after receiver e-mail addresses and contents of the mails are inputted, and extracts as many as the number of the allowable mails, then calls the icon generator (13) to deliver the provider ID. The icon generator (13) extracts items to be encoded, by accessing the DB server (11), and makes an HTML statement. The e-mail delivery processor (14) inserts the generated icon into the context of the e-mails to be delivered, temporarily stores the mails by calling an e-mail delivery server, and counts the number of the sent mails while sequentially delivering the mails one by one, then completes the procedure when all the temporarily stored mails are delivered.

If the number of the allowable mails is based on mails received by a receiver, the processor counts the mails by checking whether the receiver has received the mails. At this moment, restrictions on the number of mails can be randomly designated (counting process being omitted when it is unnecessary).

Now, a third embodiment (using a two-way calling method) of the present invention in accordance with FIG. 1 through FIG. 3 will be described as follows.

The third embodiment relates to an Internet call made in two ways with a desired party of a provider who wants to use the service.

All functions and configurations are designed by using the same e-mail as the second embodiment. But, when the provider is authenticated for reception by inputting IDs of the provider and the called party in the member management server (1), the member management server (1) separately put a mark for the authenticated IDs as receivable IDs to store the marked IDs in the DB server (11), and the called party can make a call to the provider by clicking an icon displayed on the received e-mail. If the ID of the called party is manually inputted or a call is received from the called party, the provider and the called party can make a conversation each other by automatically storing a telephone number in the buddy list DB (26).

Next, a fourth embodiment (using the system operator web) of the present invention in accordance with FIG. 1 through FIG. 3 will be described as follows.

Here, the system operator means a person who provides the overall system in accordance with the present invention and operates the whole system by receiving member registrations of the provider and the customer.

The fourth embodiment is basically the same as or similar to the multi-subscription of the first embodiment. However, instead of the click program being equipped in the provider web server (4) in the first embodiment, it is equipped in the system operator web server (1) in the fourth embodiment.

The DB server (11), the call processing server (12), the customer PC (3), and the provider PC (2) have the same functions and configurations as the first embodiment. The member management server (1) comprises as follows.

A provider information processor (15) retrieves a search keyword inputted from the customer PC (3) in the DB server (11), and provides retrieved reception function-containing provider and personal information to the icon generator (13).

The icon generator (13) generates plural click programs corresponding to a lot of retrieved provider (including the person) information, respectively, and offers the programs to a web interface (16).

A system operator web server (17) comprises the plural click programs supplied from the web interface, and displays icons associated with the programs, respectively, on the system operator web page in predetermined type.

Here, a search keyword retrieving process of the provider information processor (15) in accordance with FIG. 8 will be described in detail as follows.

When a random Internet user inputs a desired search keyword on a telephone number retrieving window by accessing the member management server (1), the user first prioritizes local retrieving conditions, then sets business category. If the provider inputs essential items (shortcut menus or telephone numbers of Chinese restaurants, flower shops, etc.) among information items inputted during subscription, the provider information processor (15) inquires about reception function-containing member IDs, firm names, and telephone numbers corresponding to combinations of inputted search keywords, from the DB server (11), temporarily stores the inquired data, and counts the number of inquired providers to sequentially make HTML statements according to each provider, then sequentially displays on a screen. Finally, when all the stored providers are displayed, the processor (15) completes the procedure.

With such a configuration, the provider having a receiving function can carry on a business such as advertising to unspecified customers even though the customer does not connect to the provider's web server (4), and the customer can also make a call with a desired provider easily on one web server (17) where a lot of information is offered. Besides, since general member information given with a receiving function can be retrieved with the use of name, address, and telephone number, acquaintances including friends or relatives can have a simple call by only clicking an icon after retrieving the name by connecting to the web server (17) of the system operator.

In the above embodiments, to supply statistical information of customers received in the provider, a call recording function is established to accumulate/record call records of the customers received in the user agent (21) of the provider PC (2) in text files. And, if the customers join in the member management server (1), a call statistical processor (18) integrates addresses and residence registration numbers of the customers stored in the DB server (11) with the customers' receiving records (IDs, receiving times, ending times, etc.), and processes the integrated information in predetermined type essential for a receiving function authenticator. Thus, the provider can extract a lot of information including information on area, gender, and age of the customers who call the provider, by accessing the call statistical processor (18), as well as the number of calls of existing customers and total call duration.

Here, a call statistical processing function by the call statistical processor (18) will be described in detail as follows, in reference to FIG. 9. When the receiving function authenticator logs in on a call statistical menu by accessing the member management server (1), the call statistical processor (18) brings call record files (generally, text files) accumulated/recorded in the customer PC (3) to the member management server (1), extracts IDs one by one according to a recorded sequence, and extracts corresponding essential items (address, gender, age, etc.) from the DB server (11) to accumulate/store the extracted items in files to be statistically processed.

If the extraction of the recorded IDs is completed, the processor calls a necessary statistical program to calculate statistical values, stores the calculated values, and displays the processed results on a screen. When comparing the calculated statistical values with the existing accumulated statistical values, the processor extracts the accumulated statistical values to compare with the existing values, and displays the compared results on the screen.

In the above embodiments, it is possible to use encoded provider information without encoding it. But, the encoded information is needed to prevent information from being used without permission of the system operator. In the present invention, the method of calling between the receiving and sending PCs is not the core factor, and a random method may be applicable.

The Internet call controlling system in accordance with the present invention can access and use a general wired/wireless telephone that employs a general PSTN, by connecting line adapters with a PC.

Such a configuration may be applied to all of the above embodiments, and has a user agent capable of solving functions performed by collective gateway systems, unlike the existing one-to-one fixed access calling method.

Namely, during multilateral calls through the call processing server (12) and the line adapters individually connected to each PC, a voice message is processed in a busy state, and during call connection with a general phone, the line adapters have functions of receiving a call with the general phone (directly coupled phone) for the moment and coping with various circumstances.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 is an overall system format diagram relating to a clicking-type Internet call controlling system in accordance with the present invention;

FIG. 2 illustrates a connected state between an internal block diagram of provider and customer PCs and line adapters in accordance with the present invention;

FIG. 3 is an internal block diagram of a member management server in accordance with the present invention;

FIG. 4 is a flow chart of a click program in accordance with the present invention;

FIG. 5 is a flow chart showing an automatic transmission of a user agent in accordance with the present invention;

FIG. 6 is a flow chart relating to icon generation in accordance with the present invention;

FIG. 7 is a flow chart relating to e-mail delivery in accordance with the present invention;

FIG. 8 is a flow chart relating to provider information processing in accordance with the present invention;

FIG. 9 is a flow chart relating to call statistical processing in accordance with the present invention;

FIG. 10 is an operation flow chart of a first embodiment of the present invention;

FIG. 11 is an operation flow chart of a second embodiment of the present invention;

FIG. 12 is an operation flow chart of a fourth embodiment of the present invention;

FIG. 13 is an operation flow chart of call statistical information processing of the present invention;

FIG. 14a through FIG. 14f are flow charts relating to a telephone receiving function through line adapters of the present invention; and

FIG. 15a through FIG. 15c are flow charts relating to a telephone sending function through line adapters of the present invention.

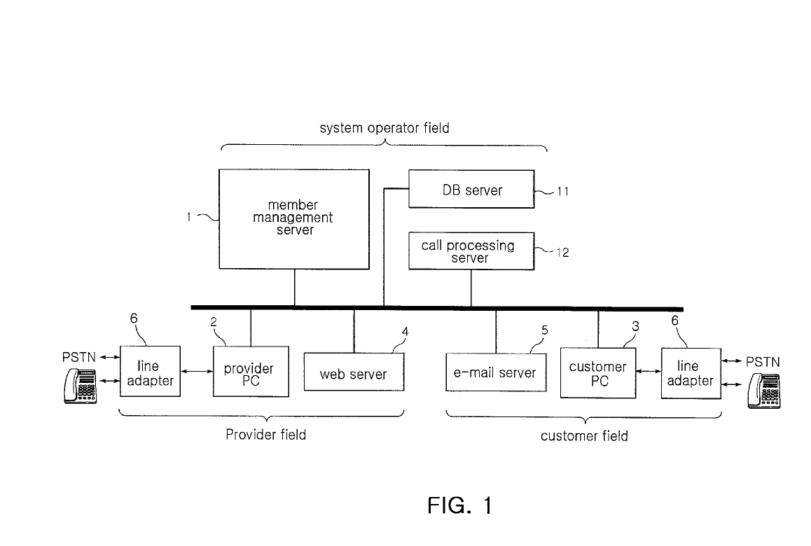

### EMBODIMENT

Operations and effects of the present invention configured like above will now be fully described in reference to each embodiment.

First, a service in accordance with the present invention is supplied to joined members only, and user agents (21,31) should be equipped in a user PC (provider or customer).

However, for the customer, it is automatically installed during initial use.

Basically, the present system is provided for benefits of advertising and business of the provider. So, the provider who wants to actively join in the present system for business profits has to join the system with fee (in some cases, operate free of charge according to selection of the system operator).

[Membership Process]

(For Paid Member)

The paid member for joining the present system should first input required subscription information including a provider (specific person) ID, a telephone number, an address, and a search keyword in a web server (17) of a member management server (1) provided by the system operator.

In case of paid service, the member is registered as a provider (depending on whether a receiving function is established) through payment.

The member management server (1) separately marks (add a specific code to the ID) the information on the registered provider (specific person) to store the marked information in a DB server (11), encodes selected essential items such as a firm name, an ID, and a telephone number in an icon generator (13), and supplies a click program. The provider is supplied with his click program from the web server (17), and inserts the supplied click program into a predetermined position of the provider's web page.

Here, it is desirable to make the click program in HTML (Hyper Text Markup Language) type. But, though the program is made in other methods, it can be included in a category of the present invention.

At the same time, the user agent (21) should be installed in a provider PC (2) for call with the customer.

To do this, it is necessary to click an icon of the system operator displayed on a web page by connecting to the web server (17) of the system operator.

Once the icon is clicked, the user agent (21) is automatically installed in the provider PC (2) like shown below, by the click program of the system operator comprised in the system operator web server (17).

Therefore, a preparation required for subscription service for the paid member can be simply finished.

(For Free Member)

Next, in case the customer wants to join in the present system free of charge, like the paid member, the customer first inputs required information (ID, password, name, address, etc.) like the provider on a member subscription window by connecting to the web server (17) of the system operator. Here, it is desirable to set the customer ID to a valid e-mail address (because the provider can use the address to send e-mail to the customer).

Accordingly, the free member can finish the membership process, and the user agent (31) to be installed in a customer PC (3) may be automatically installed by clicking an icon on a web page of the system operator (separate installation method can be also usable), or can be installed by clicking a provider icon on the web page of the provider.

It is because the provider already has the click program having the same function as the system operator web server (17) in his web server (4) during the member registration.

But, if the sending user agent (31) is previously installed in the system operator web server (17) during the member registration for user convenience, it is possible to shorten the time for automatically installing the user agent (31) among click programs equipped in the provider's web server (4), in case the customer wants to call a random provider later.

Here, an operational process for the generation and execution of the click program will be fully described as follows.

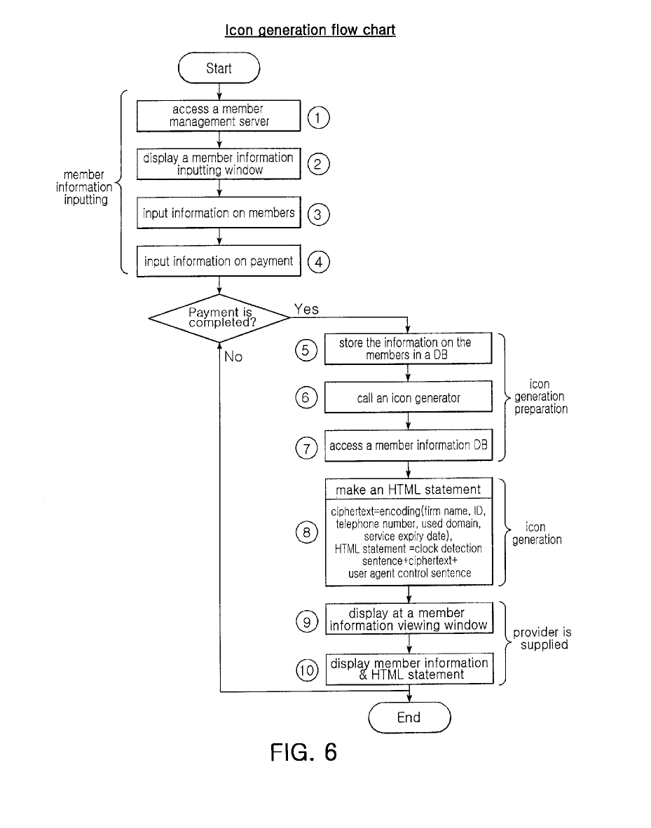

Referring to a flow chart of FIG. 6 relating to a process of generating the click program by the icon generator (13), \textcircled{1} the provider accesses the member management server (1), and \textcircled{2} on a member information input window, \textcircled{3} the provider inputs all of the member information, \textcircled{4} and when the member registration is authenticated, \textcircled{5} the member information is stored in the member information DB server (11) in receivable data state, \textcircled{6} and the icon generator (13) is called \textcircled{7} to access the DB server (11), \textcircled{8} then predetermined items is selected/extracted from the stored information to form a ciphertext, and if the icon is clicked, the click program which adds a click detection statement for detecting the icon to a statement for controlling the user agent of the customer PC (3) is generated, \textcircled{9}\textcircled{10} then the program is displayed on a member information viewing window, so that the provider can copy the program. When the provider copies the generated click program on his web page to insert the program, the icon is displayed, and if the icon is clicked, the following process is executed.

(Click Program Operational Process)

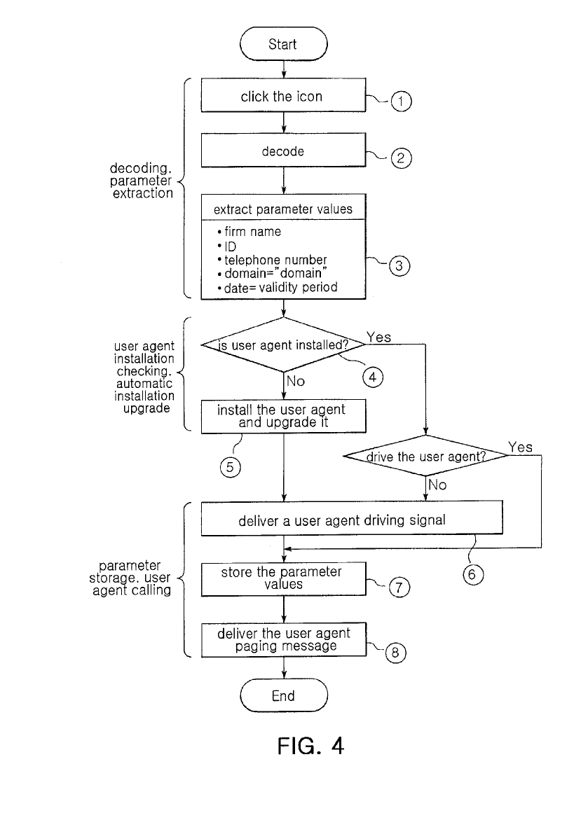

Like FIG. 4,

\textcircled{1} The customer clicks the icon.

\textcircled{2} Parameter values such as the firm name, the ID, and the telephone number of the provider encoded in association with the icon are decoded.

\textcircled{3} The decoded parameter values are extracted.

\textcircled{4} Then, it is checked whether the user agent (31) is installed in the user agent (31).

\textcircled{5} If not, the user agent (31) comprised in the member management server (1) is downloaded to the customer PC (3), so that the use agent (31) can be automatically installed. And, if the user agent (31) is already installed, the agent (31) is automatically upgraded when necessary.

\textcircled{6} If the user agent (31) is installed or the installation is finished like \textcircled{5}, a starting signal for letting the user agent (31) be in working state is sent.

\textcircled{7} Then, the extracted parameter values of \textcircled{3} are stored.

\textcircled{8} A message for calling the user agent (31) is delivered. Thus, the operational process of the click program is completed. That is, the present invention automatically executes an existing function of a sender examining receiver information through inconvenient procedures and individually inputting the information, in software way. Moreover, in case of PCs where the user agents (21,31) needed for controlling receiving/sending calls are not installed, the member management server (1) automatically downloads the user agents to install them in the PCs.

Accordingly, the first user can simply use the agents. And, if a version of the user agent is up, a version of the existing user agent is checked to conduct an automatic upgrading function when deemed necessary.

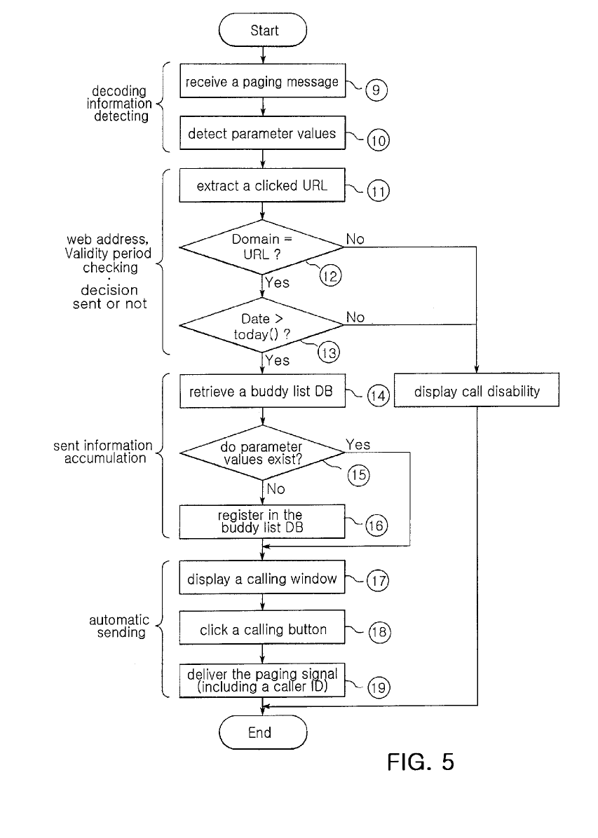

Next, an automatic sending operational process of the user agents (21,31) will be described in detail as follows, in reference to FIG. 5.

\textcircled{9} The sending user agent (31) receives the calling message of \textcircled{8}.

\textcircled{10} The stored parameter values of \textcircled{7} are detected.

\textcircled{11} A URL of the web page where the icon is clicked is extracted, and if the URL is identical with the web address of the provider authenticated during subscription (if not, stop the execution),

\textcircled{12} A validity period is checked again (if not, stop the execution)

\textcircled{13} If the validity period does not expire,

\textcircled{14} a buddy list DB (36) of the customer PC (3) is retrieved.

\textcircled{15} It is checked whether the parameter values exist in the buddy list DB (36).

\textcircled{16} If not, the values are additionally registered in the buddy list DB (36).

\textcircled{17} The parameter values detected from \textcircled{10} are displayed on a calling window.

\textcircled{18} When the customer clicks a send button,

\textcircled{19} a provider ID required for sending is extracted, and is delivered together with a customer ID as a paging signal to the call processing server (12). As a result, the automatic sending operational process of the user agents (21,31) is completed. Namely, the present invention extracts stored receiver information by executing the click program, confirms whether the provider is authenticated for use, and stores the sending information while automatically sending the information. The above process refers to an automatic software execution with regards to an existing process of sending a manually inputted telephone number.

So far, all of a series of processes related to the execution of the click program have been explained. Still, it is available to partially change an operational sequence or functions when deemed necessary.

To summarize the above contents again, when the customer clicks the displayed icon by accessing the web server (4) of the desired provider, the click program comprised in the web server (4) is executed. First, the encoded parameter values of the icon retaining provider are extracted like \textcircled{2} and \textcircled{3} (supposing that the user agent is already installed), the parameter values are stored like \textcircled{6}, \textcircled{7}, and \textcircled{8}, and the user agent (31) is driven).

Then, the user agent (31) detects the parameter values to send the detected values together with the sender (customer) ID like \textcircled{9}˜\textcircled{19}.

Here, to perform a substantial transmission function, a login process is demanded, so that the call processing server (12) must previously recognize a customer's ID through the customer PC (3) before carrying out a sending command.

Otherwise, even though a paging signal is delivered according to the sending command, the call processing server (12) does not recognize the delivered signal, resulting in incapability of sending process.

Also, in the event that the user agent (31) does not have to be additionally installed in the customer (sender) PC (3) \textcircled{17}, processors \textcircled{4} and \textcircled{5} need not be included. When information on the provider sent by the customer does not have to be stored in the present system, processes of \textcircled{1}˜\textcircled{16} can be omitted. And, if a call is automatically made to the provider as soon as the icon is clicked, the processes of \textcircled{17}\textcircled{18} can be omitted (possible to let the customer select the automatic or manual function).

Like shown above, basically, the click program in accordance with the present invention automatically installs the user agent essential for a PC to use this service in accordance with the present invention, when the customer clicks the icon to make a call with the provider, and has a series of processes for automatically sending the call to the provider associated with the icon by the user agent. Therefore, if the customer wants to use the call service of the present invention with the provider, the customer may easily and immediately make the call with the provider by only pressing the icon of the provider, even though it is the first use, thereby inducing the general customer to simply and conveniently contact the provider for purchase in a short time at any time. As a result, business efficiency can be increased. Furthermore, profits of the system operator may be augmented thanks to a business growth for both provider and customer.

Also, it solves the existing problems that the customer should separately inquire about an Internet telephone number and an ID of a called party and press a send button by manually input all required items on a calling window again. And, it can recognize customer information sent to the provider while storing the recognized information, and may use the stored information for business activities. That is, it is a core function and configuration needed for supplying the service in accordance with the present invention.

Basically, it is desirable to make the click program in HTML type. The user agents (21)(31) are separately comprised in the member management server (1) and the click program is automatically downloaded for installation by the HTML statement. It is because, if not only do the user agents (21)(31) perform functions of \textcircled{9}˜\textcircled{19} of FIG. 5, but the agents may carry out a lot of functions such as Internet call control and line adapter control functions including the provider and the signal processors (24)(34) of the customer PCs (2)(3), a great number of capacities are basically necessary for conducting the above functions. However, in case of performing some simple functions only, the program can be included in the HTML statement without setting a separate program.

In addition, it is available to install the user agent (31) comprised in the provider web server (4) by the click program of the provider web server if the customer presses the icon, by locating the user agent (31) in the web server (4) of the provider. But, at this point, though it is desirable to offer the user agent (31) a download program of the HTML type, which consists of the same contents of execution program, in a predetermined position in the web program (ex, predetermined position in the member management server (1)), it is undesirable in terms of efficiency since the provider web server (4) has a variable characteristic, causing the download program to be located at different positions in every provider web server (4). As a result, the contents of the HTML-type program should be changed according to these different positions. So far, the sending functions of the user agent and the processes thereof have been explained. As for receiving functions and processes thereof, they have been only explained that the receiving PC recognizes a receiving signal and delivers a response signal in each embodiment. Thus, the receiving functions and the processes thereof will be specially described after explaining all the embodiments, since detailed operations after the paging signal is received are the same as all of the embodiments.

### First Embodiment

### Using the Provider Web

If the customer wants to directly call the provider, the customer clicks the displayed icon of the provider by connecting to the provider web server (4).

When the icon is clicked, a click program which includes unique provider information supplied through member authentication from the system operator and is located in a predetermined position of the provider web server (4) is executed. That is to say, like shown in FIG. 4, the clicked unique provider information is decoded to extract unique information parameters of the provider, and a driving signal is sent to the user agent (31) installed in the customer PC (3), while the extracted unique provider parameter values are stored, then a calling message is delivered to the user agent (31). Like shown in FIG. 5, the user agent (31) which has received the delivered signal detects the stored unique parameter values of the provider, and delivers a paging signal composed of an ID (name can be added, when necessary) of the provider desired by the customer for call and a customer ID itself to the call processing server (12).

The operational process explained above relates to a process of transmitting a sending signal by automatically executing the click program, once the customer clicks the icon displayed on the web page of the corresponding provider so as to make a free Internet call with the desired provider. Through the above operational process, the customer can simply send a call to the desired provider by clicking the icon.

Here, if a customer who uses the system in accordance with the present invention for the first time joins in the system and does not previously download the user agent (31) from the web server (17) of the system operator for installation, the agent is automatically installed by the processes of \textcircled{4} and \textcircled{5} of FIG. 4. So, it causes no trouble. In addition, the process of automatically storing unique information on the provider called by the customer is carried out by the operational processes of \textcircled{4} to \textcircled{16}.

Then, since the call is enabled by recognizing an ID of the customer PC (3) which is the sender and an ID and an IP position of the provider PC (2) which is the receiver, by the call processing server (12), the customer should log in the provider and customer PCs (2)(3), and should previously recognize the IP address of the provider PC (2) in the call processing server (12).

So, when the customer PC (3) delivers the paging signal through the above procedure, the call processing server (12) inquires about the IP address equivalent to the received ID of the provider PC (2) in the DB server (11) (or, temporary memory of the call processing server), and relays the paging signal to the provider PC (2).

The paging signal is received in the user agent (21) through an SIP signal processor (24) of the provider PC (2), and a response signal is delivered to the customer PC (3), so that the customer PC (3) and the provider PC (2) can do an Internet call while a customer ID and a name included in the paging signal are automatically stored like shown below (will explain in the user agent receiving operational process).

As a result, the customer can simply make the Internet call with the desired provider by clicking, and the provider can provide a high-quality service as well as conduct an enhanced customer management.

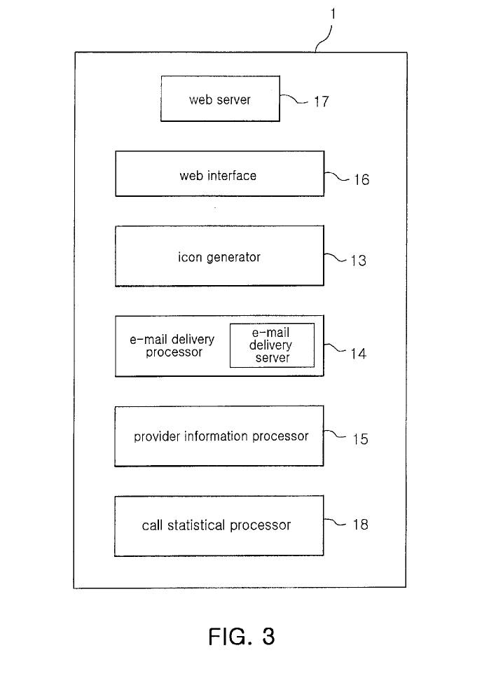

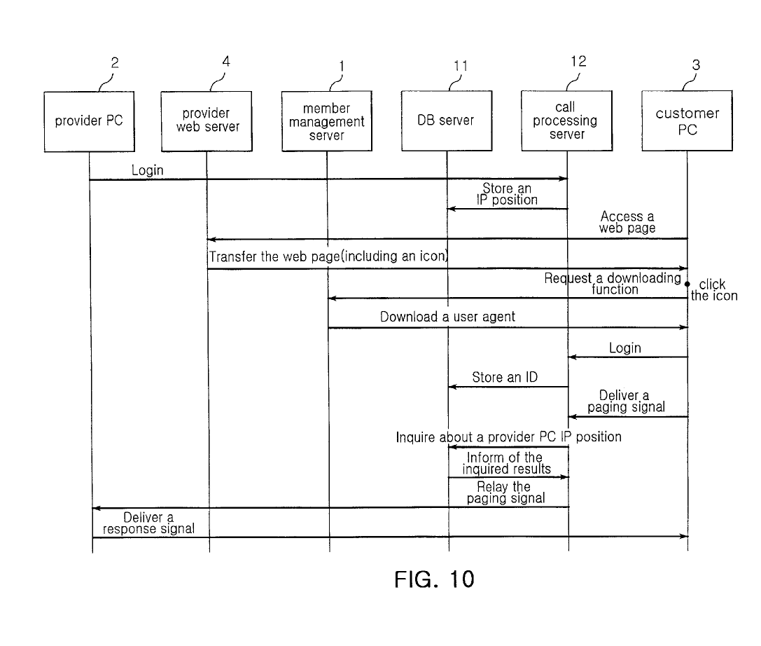

Namely, since a function of storing the customer ID received in the user agent (21) of the provider PC (2) in the buddy list DB (26) is assigned, the provider can carry on higher-level business activities such as advertising and publicity by sending e-mail to the received ID (e-mail address) for the customer who is interested in the provider's business. Besides, for the customer, provider information called by the customer is automatically stored through the processes of \textcircled{14}˜\textcircled{16} of FIG. 3. Thus, the customer can immediately inquire about or send the stored information in the customer PC next time. This can be explained by an operational flow chart of FIG. 10. Referring to FIG. 10, given that the provider and the customer have joined the system, the provider logs in to register an IP address of the provider PC (2) in the call processing server (12), so that the call processing server (12) can store the registered IP position in the DB server (11).

If the user agent (31) is not installed in case the customer clicks the displayed icon by accessing the web server (4) of the provider, the agent is automatically installed, and an ID of the customer PC (3) that the customer logs in is stored in the DB server (11) through the call processing server (12). Then, the call processing server (12) relays the paging signal delivered from the customer PC (3) to the IP address of the provider PC (2) inquired about through the DB server (11), and the provider PC (2) that has received the paging signal delivers a response signal to the customer PC (3) to start an Internet call.

Also, in the first embodiment, if providers such as Internet shopping mall providers want to use the service in accordance with the present invention for each product while advertising the plural products, for instance, if all of a provider (A) overall operating a shopping mall, a provider (B) carrying on a business by posting a cellular phone advertisement on a shopping mall web page of the provider (A), and a provider (C) conducting business by posting a camera advertisement want to use the service of the present invention, all configurations, functions, and operational processes are perfectly the same as the first embodiment.

However, on this occasion, 3 unique click programs for the providers (A, B, C) received from the system operator by separately joining as members in the web server (4) of the shopping mall provider (A) are separately comprised in predetermined positions, respectively, so that the click programs are displayed by special icons on the web page of the same shopping mall provider. Among them, a click program only, which is associated with an icon clicked and selected by the customer, is executed to make the customer directly call the corresponding provider.

Like above, in the present embodiment, if icons (regardless of the number of icons) are displayed on the web page of the provider, a variety of services can be provided to the customer for various purposes of the provider.

### Second Embodiment

### Using E-Mail

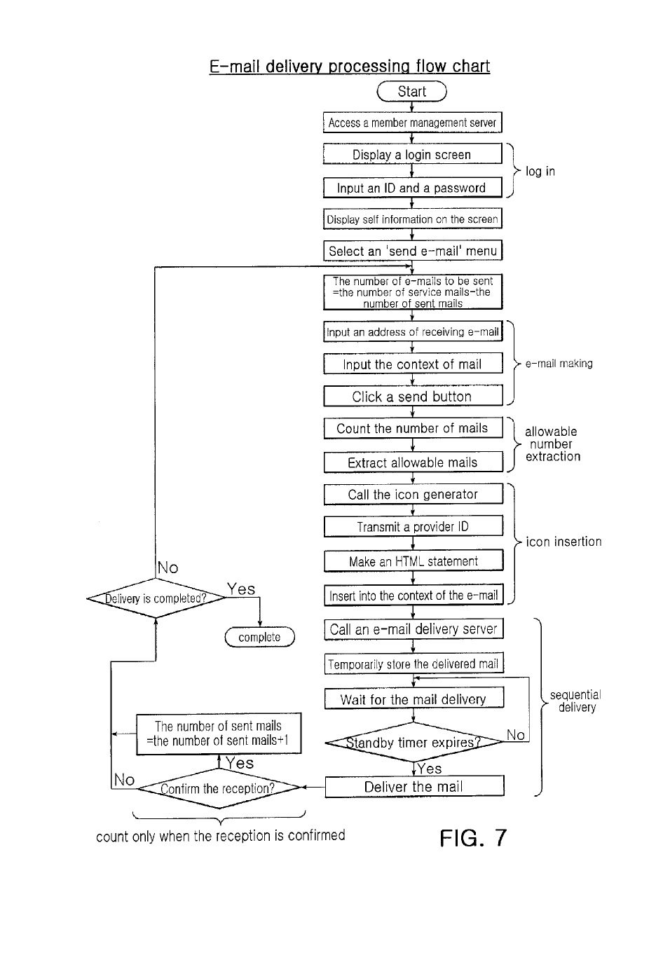

In case the provider sends e-mail for product advertising to unspecified customers, the provider first accesses the member management server (1) to input contents of an e-mail to be sent to the customers and e-mail addresses of the customers on an e-mail window supplied from the system operator, and clicks a send button. Then, the e-mail delivery processor (14) inserts a click program having unique information of the provider into the provider's e-mail, and sends the e-mail to the customers (see a flow chart of FIG. 7 relating to the second embodiment).

The e-mail receiving customers access the e-mail server (5) with each customer PC (3) to download the e-mail, and click the icon of the provider displayed on the e-mail. Then, the click program is executed, so that the customers can make calls with the provider by the same process as the first embodiment.

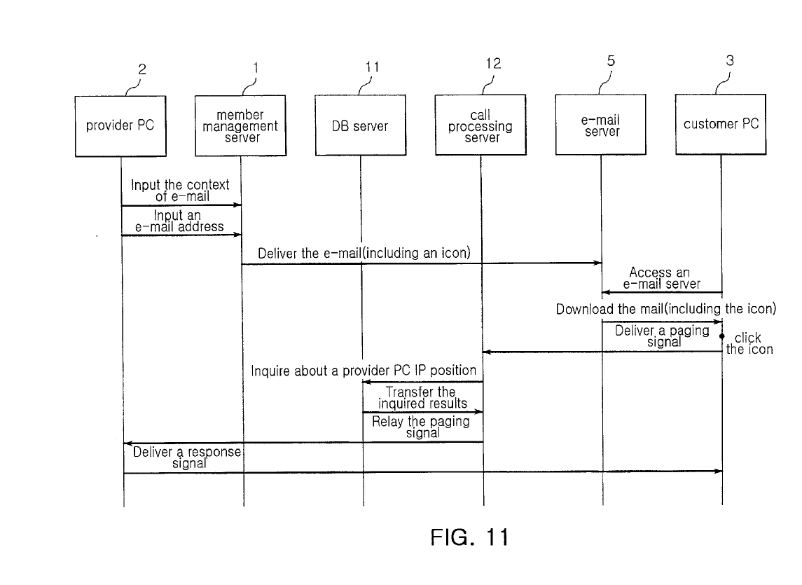

That is, compared to the first embodiment, the provider makes the e-mail in the member management server of the system operator while inserting the icon and sends the made e-mail, thus there is a difference between the icon displayed on the web page of the provider and the icon displayed on the e-mail. Except this fact, all of other functions and operations are the same as the first embodiment. This will be fully described in reference to an operational flow chart of FIG. 11. First, if a provider logs in at a member management server (1), and inputs contents of e-mail to be sent to a customer and an e-mail address of the customer on an e-mail window, a click program having unique provider information is inserted into the e-mail, and the e-mail is delivered to an e-mail server (5). If the customer accessing the e-mail server (5) downloads the e-mail and clicks the icon displayed on the e-mail, a customer PC (3) delivers a paging signal to a call processing server (12) by the click program executed by the icon, and the call processing server (12) which has received the paging signal inquires about an IP address of a provider PC (2) in a DB server (11), and relays the paging signal, then the provider PC (2) which has received the signal delivers a response signal to the customer PC (3), so that the customer and the provider have a conversation on the phone.

Currently, when the provider sends an e-mail advertisement to unspecified Internet customers by asking a self or an external expert institute, most of the customers who have received the advertisement see an e-mail title only, or some of them read the whole sentence, but the customers should connect to a web page of the provider for asking or ordering through complex procedures. Furthermore, even in case of asking or ordering by the customers, they cannot receive answers, or even though they want to directly call the provider, it is inconvenient to find a contact number and to make a call with the found telephone number, thus it is difficult for the customers to easily access the service. And, as for a clicking system by a simple link, it expires one time only, disabling the provider for conducting a follow-up control for the customers. However, the second embodiment in accordance with the present invention is very useful for both customer and provider.

So to speak, the provider can offer a certain condition that the provider can immediately call the customer in simple way when necessary, thereby realizing customer convenience. And, since the provider can recognize the customer's received ID, the provider may provide a differentiated service as well as effective business activities by distinguishing desired customers only, who are interested in the provider's business, instead of unspecified customers.

### Third Embodiment

### Using the Two-Way Call System

The present embodiment is configured to enable the provider to make a two-way call with a called party without costing the other party or inconvenient procedures, targeting on foreign branches or main customers. If the provider, the paid member, designates a desired called party, a receiving function is given to the designated party for free.

First, when the provider registers in the member management server (1) according to a paid member registration procedure, the provider registers with IDs having the receiving function as many as the predetermined number of called parties given with the receiving function for free.

The member management server (1) distinguishes into receivable IDs, and stores the distinguished IDs in the DB server (11). Certainly, it is possible to add a function of distinguishing a free function from a paid function, for service discrimination.

For example, anyone can use free telephone numbers of called parties, but the click program is not provided. Thus, a function of sending a call to the called parties through clicking functions is not assigned. This is not expanded as options for the system operator.

When the called party is registered, the provider sends an icon to the called party. At this moment, like shown in the second embodiment that the provider sends the e-mail to the customer, an e-mail address (ID) of the called party and an announcement are made on the e-mail window of the member management server (1), and the e-mail is sent to the called party. Then, the e-mail delivery processor (14) inserts the click program containing unique provider information into the e-mail, and delivers the e-mail to the e-mail server (5). The called party opens the received e-mail, and clicks the icon of the provider displayed on the e-mail. When the icon is clicked, the click program of the provider is executed like mentioned above. As a result, the user agent (31) is automatically installed in the called party PC (3), and provider information (name, ID, telephone number, etc.) is automatically stored in the buddy list DB (36) of the user agent (31) of the called party PC (3), so that the called party can send a call to the provider through clicking functions at any time when necessary. So, the called party may have benefits of calling the provider as well as using a receiving function free of charge without a separate procedure. At this time, a telephone number of the called party is given during member registration in the member management server (1). Meanwhile, the provider installs the user agent (21) by clicking the icon of the system operator after joining in the member management server (1), manually inputs the ID and the telephone number of the called party in the self PC (2), or stores information on the called party received by the user agent (21) in the buddy list DB (26) when the called party makes a call, so that the provider can send a call to the called party at any time.

In terms of making Internet calls by both provider and customer in two ways, the present embodiment is the same as or similar to other currently used methods. However, the present invention has improved an existing problem that calls are connected among paid members only for the Internet phone provider that provides the system service in order to carry out two-way calls. Namely, in the prior art, if a certain trader wants to frequently make calls with overseas buyers worldwide at low-priced Internet calls, the trader has to request the desired buyers to join in a service system of the trader as well as the trader himself or herself, and after joining, information required for the Internet calls is exchanged between the trader and the buyers, and stored, respectively. In this case, substantially, it is not in reason for the trader to ask the buyers, the customers, to join the service system. But, like shown above, the present embodiment enables the trader (specific person) only to join as a paid member, while letting other party, the customer, receive all services through e-mail for free. Accordingly, the customer can make a call with the trader by only clicking the icon without an economical burden or complex procedures, while the provider himself or herself can make the call with the customer at low price, thereby offering a very useful service for both provider and customer.

Since the e-mail delivery process, the core operation of the present embodiment, is the same as the second embodiment, separate explanations on the e-mail delivery processing flow charts and the operational flow charts of FIG. 7 and FIG. 11 will be omitted.

### Fourth Embodiment

### Using the System Operator Web

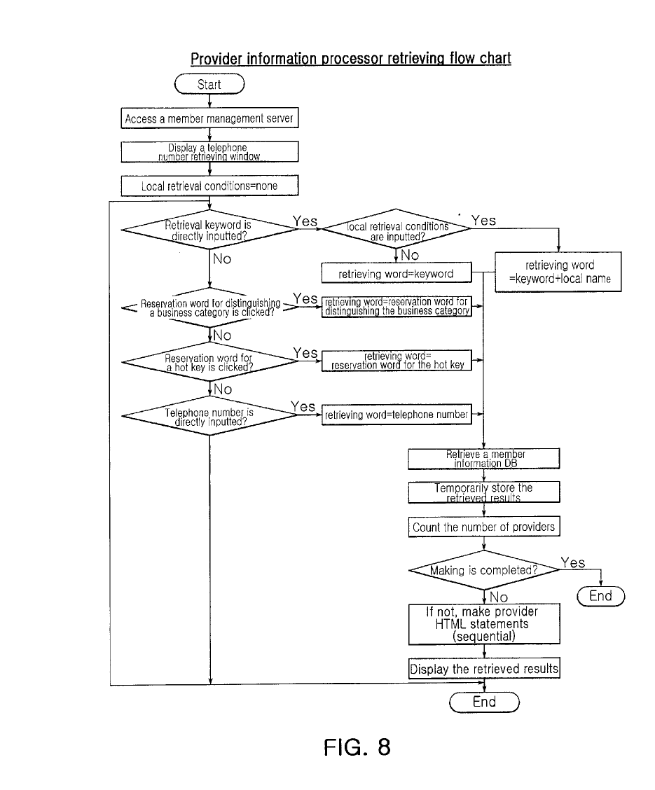

Basically, all functions and operations of the present invention are the same as or similar to the first embodiment for letting the customers call the provider by using the web server (4) of the provider. But, there is a difference of using the web server (17) of the system operator, rather than using the provider web server (4). First, all of provider information assigned with a receiving function through paid member registration is stored in the DB server (11) of the system operator. Here, the customer connects to a phone book search window of the system operator to make a call with a desired provider, and accesses on a telephone directory retrieving window. The customer inputs a search keyword (ex, travel agency located at Guro-gu, Seoul) requested to search for the desired provider among a lot of providers. The provider information processor (15) inquires about the provider information stored in the DB server (11), and provides provider information equivalent to the inputted search keyword to the icon generator (13) such that plural click programs corresponding to each provider, respectively, can be generated and inserted into predetermined positions on the web page of the system operator through the web interface (16), then icons associated with the click programs, respectively, are displayed on a web page accessed by the customer together with provider information lists such as firm names, telephone numbers, business categories, and addresses. That is to say, the provider information corresponding to the desired keyword of the customer is provided to all free customers in the web server (17) of the system operator together with icons (see detailed explanations in the flow chart of FIG. 8 relating to the fourth embodiment).

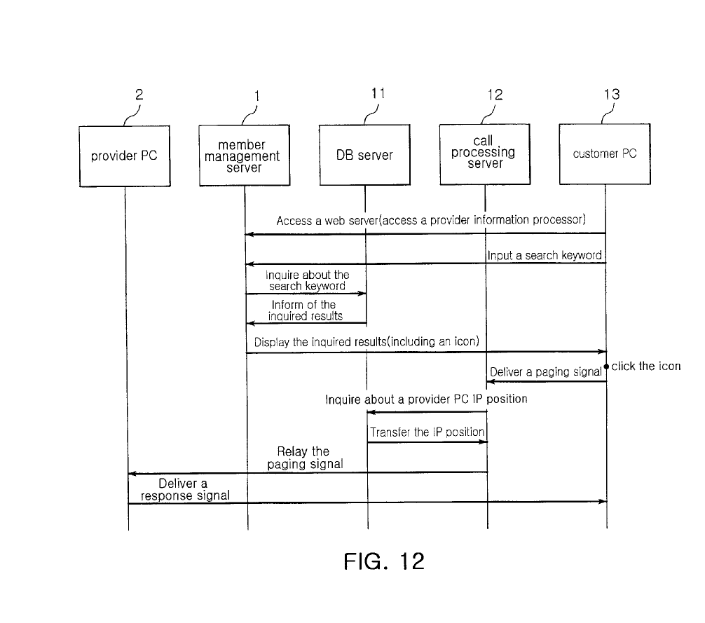

If the customer clicks an icon of the desired provider among the displayed providers, like shown above, an associated click program is executed. The free/paid member registrations and the login processes are shown above, and it is possible to selectively set a manual or automatic operation for call transmissions. In case of sending through automatic or manual functions, a paging signal containing the customer ID is delivered to the call processing server (12). The call processing server (12) which has received the signal relays the paging signal to an IP position of the provider PC (2) inquired about in the DB server (11), and a call is mutually connected by delivering a response signal from the provider PC (2). Referring to FIG. 12 relating to the above operation, if a customer accesses a web server (17) of the system operator and inputs a search keyword for retrieving a desired provider on a telephone directory retrieving window, a provider information processor (15) extracts provider information through a DB server (11), and provides the extracted information to an icon generator (13) such that each unique provider click program can be generated, respectively, to be displayed with icons on provider lists such as firm names, business categories, telephone numbers, and addresses of each provider. When the customer clicks an icon of the desired provider, a paging signal is relayed to the provider PC (2) by the call processing server (12) and the DB server (11) like shown above, through a click program associated with the clicked icon, so that the customer can make a call. The present embodiment is characterized by complementing problems of the first embodiment that the present service is provided to customers only who access each web server (4) of providers. In other words, if a customer wants to know a particular area instead of a particular provider, for example, a travel product, the customer can receive a lot of travel agency lists by connecting to the web server (17) of the system operator where lots of related information is summed up. In addition, if a customer living in Guro-gu, Seoul wants travel agencies only, which are located in Guro-gu, the customer can receive lists on the Guro-gu located travel agencies only by using the keyword searching function. Among them, if only the customer clicks an icon of a desired travel agency, the customer can simply ask about or purchase a product. So to speak, icons displayed on each individual web server (4) of each provider are integrated, in order that the customers can select all of the icons in the system operator web server (17), thereby being beneficial for both providers and customers.

Until now, each embodiment has been fully described, and like shown above, each embodiment is a service model partially applied according to characteristics of each service on the basis of core configurations and functions such that the receiver can recognize a caller ID while at the same time making an Internet call by clicking.

As for the present service, if the system operator who basically provides the service operates it for profitable business, it is offered to a provider who tries to actively use the service with fee. Instead, for general Internet users (customers, called parties) who act passively without necessarily using the service, it is desirable to provide the service for free. The above embodiments may independently realize services, respectively, and can operate the services by partially or overall incorporating them. In case of the independent operations, compared to the member management server (1) which carries out all functions of recognizing/storing a customer ID transmitted when the customer logs in, by the call processing server (12) or the DB server (11), and of checking whether the ID is overlapped with other customer's ID to store the other ID when the other customer logs in, the DB server (11) or the call processing server (12) can process the above functions. At this time, the customer can immediately use the present service by only logging in without a separate membership procedure.

(Call Statistical Processing Service)

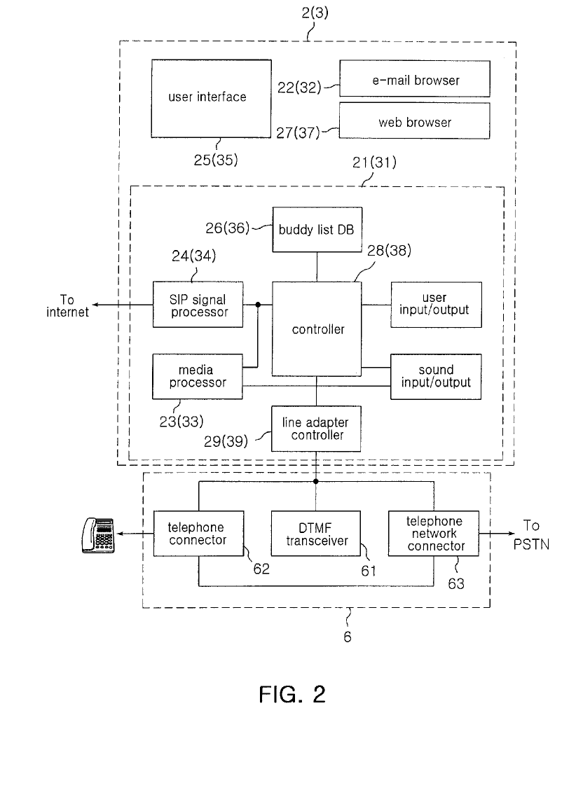

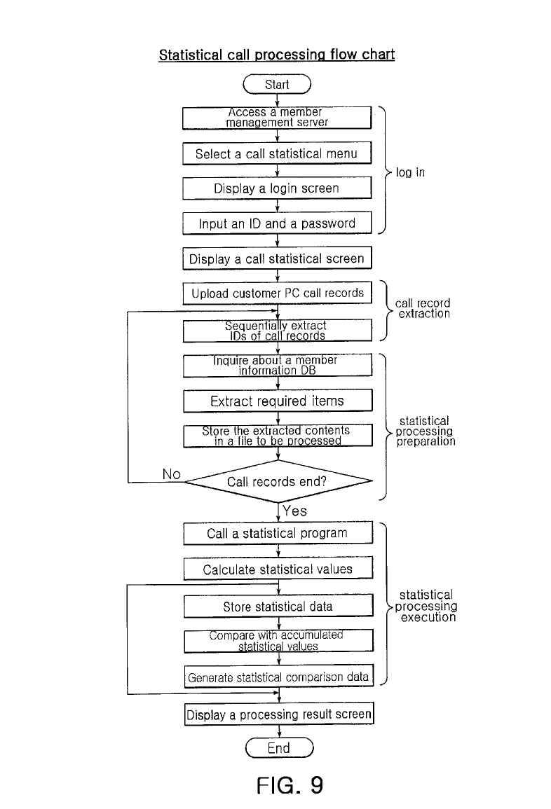

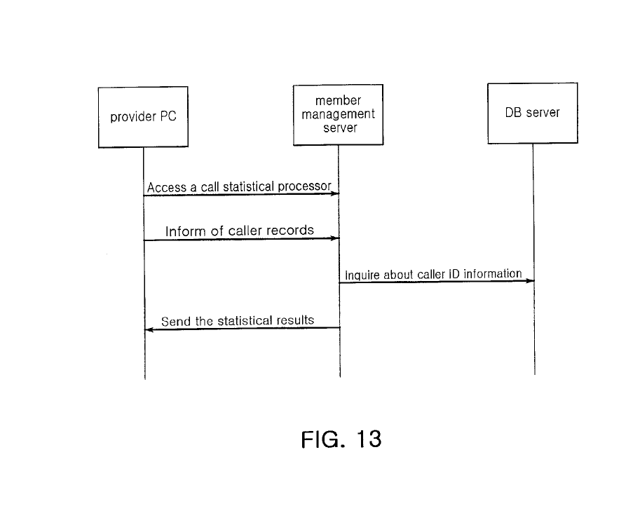

In the above embodiments, it is available to additionally supply the present status and a lot of statistical information on customers received in the provider for provider convenience. To do this, a receiving call automatic recording function is equipped in the receiving user agent (21) of the provider PC (2) of FIG. 2. So, in the above embodiments, IDs, dates of call, starting times, and ending times about the received customers are automatically accumulated/recorded in text file type. If the provider wants to report statistical information on the received customers, the provider accesses the call statistical processor (18) of the member management server (1) of the system operator, and applies for a statistical processing function. Then, the call statistical processor (18) uploads all receiver information recorded in the provider PC (2) to receive the uploaded information, and inquires about all of member subscription information (ex, residence registration numbers, addresses, gender, etc.) of the customers stored in the DB server (11) based on caller IDs, and derives essential call statistical information. In other words, the processor displays statistics about areas, ages, gender, and periods or statistical results on call duration, the number of new member calls, the number of existing member calls, and period fluctuations in various charts or graphs, then provides the displayed data (see the above process in the flow chart of FIG. 9 relating to the call statistical processing). Referring to an operational flow chart of FIG. 13, when a provider requests a member management server (1) to process call statistics of a customer, a call statistical processor (18) receives reception information recorded in a provider PC (2), inquires about member information stored in a DB server (11) based on a caller ID, and collects/statistically processes the two information to provide the results to the provider PC (2) in predetermined type. Such an additional service is substantially very useful for the provider, and like mentioned above, it is available to realize the service in the system only in accordance with the present invention, which is capable of recognizing the caller ID of the customer who calls the provider. All the receiving/sending operations mentioned so far are based on operations between PCs over the Internet. The present invention is configured to conveniently use a directly coupled telephone usable in place of a headset for receiving/sending calls or a PSTN telephone connected to a general PSTN by connecting the telephones with each line adapter (6) individually coupled with each PC.

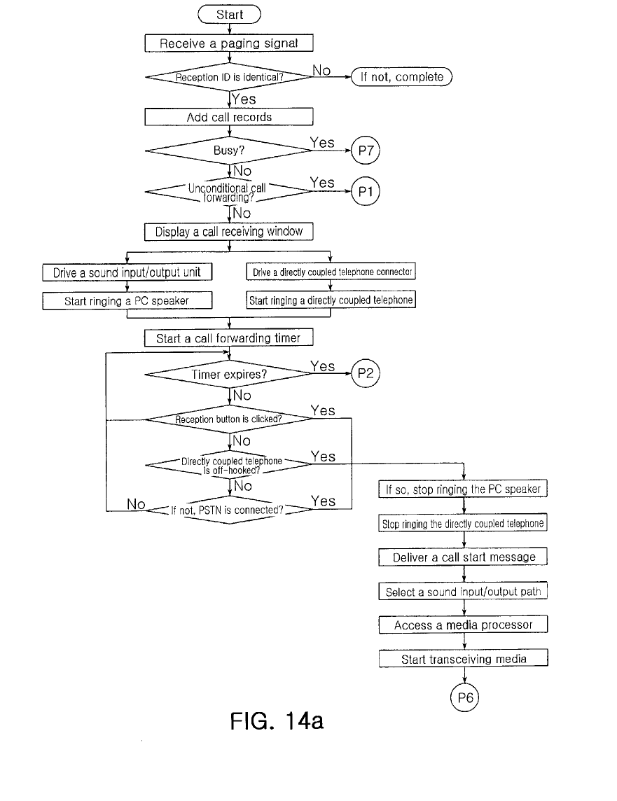

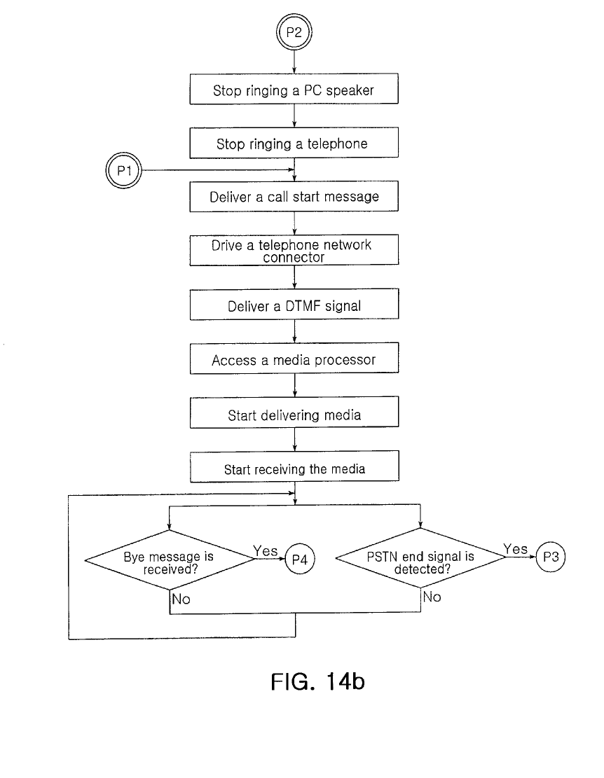

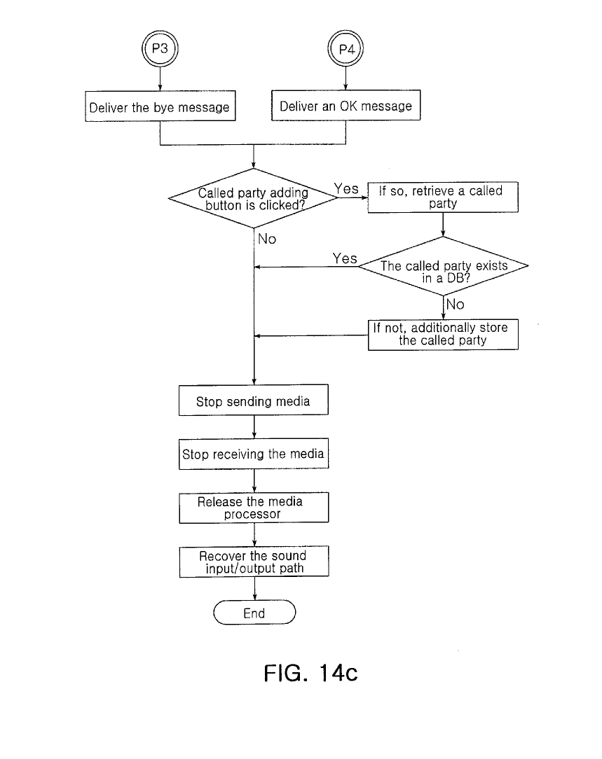

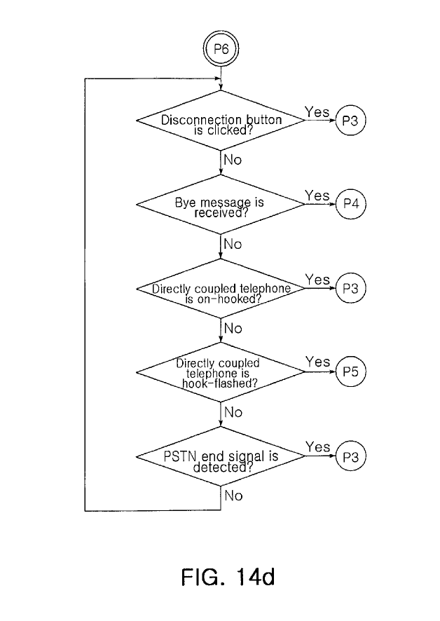

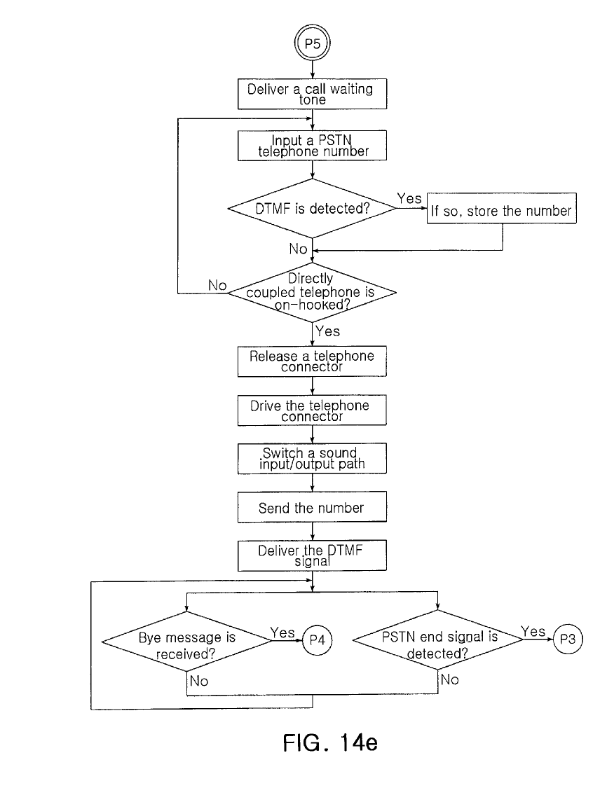

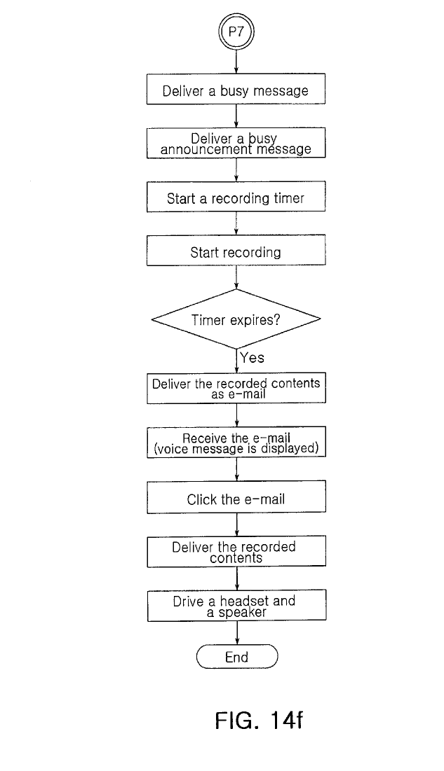

First, in reference to FIG. 2 and FIG. 14a, a receiving operational process of the user agent (21) will be described in detail as follows.

When the paging signal relayed by the call processing server (12) is received, the signal processor (24) compares whether a receiving ID included in the paging signal is identical. If not, the processor completes the procedure. If the ID is identical, the controller (28) checks again whether the line is busy.

If so, like shown below, a voice message handling process (P7) is progressed. If the line is not busy, the signal processor (24) delivers a bell message which alerts a call start.

At this time, the controller (28) checks whether a receiving PC is unconditionally set in a call forwarding mode to use a telephone connected with the PSTN via the line adapters (6) instead of the PC. If so, a call start message is delivered to a sender side from the signal processor (24) like a P1 process of FIG. 14b. And, the line adapter controller (29) drives the telephone network connector (63) to deliver a PSTN telephone number of the DTMF transceiver (61), and a media signal transceived by accessing of the controller (28) to the media processor (24) is delivered and received. Thus, a call can be connected with the sending customer, by receiving the call with the telephone connected with the PSTN.

Subsequently, when the call begins, the signal processor (24) checks an end message delivered during call completion of the sender side, and if the message is received, the processor delivers an OK message.

At the same time, if the DTMF transceiver (61) detects a PSTN end signal generated when the PSTN telephone that has received the call is completed, the signal processor (24) delivers the end message.

Therefore, when a call completion signal is detected from a certain side during the call, the call is finished. And, the controller (28) decides whether to store sender information (click a called party adding button). If the button is clicked, the sender information is retrieved from the buddy list DB (26) to decide whether sender information to be added is already stored. If not, the sender information is additionally stored.

Next, the media processor (24) stops a media transmitting/receiving process, and the process is released in the controller (28). The controller (28) recovers a sound input/output path to an initial state. It means that the user agent (21) is in initial state for receiving/sending.

In the above configuration, if it is not the unconditional call forwarding mode, the PC and the directly coupled telephone are driven for the moment, and are ringing for a certain period of time. That is to say, the controller (28) starts ringing a PC speaker through the user interface (25) by displaying a call reception window in the receiving PC and driving the sound input/output unit within the PC, and at the same time, the line adapters (6) drive the directly coupled telephone connector (62) to start ringing the directly coupled telephone.

In a set standby state, if an ACK state is recognized in any one of the PC itself, the directly coupled telephone, or the PSTN-connected telephone, the controller (28) stops all the ringing processes, and the signal processor (24) delivers a response message to the sender side while connecting the sound input/output path to a receiving side, then the media processor (23) is connected to start a transceiving process.

If a call completion state is detected from either the sender side or the receiving side (PC, directly coupled telephone, PSTN telephone) during the transceiving process, the procedure is finished by (P3)(P4) processes of FIG. 14c.

But, in case of the directly coupled telephone, it can be hook-flashed so as to transfer the call to the PSTN telephone instead of being in the call completion state, thus in this case (P5 process, FIG. 14e), the media processor (23) delivers a call waiting tone to the sender side while the DTMF transceiver (61) detects a PSTN telephone number received from the directly coupled telephone to store the telephone number. If the directly coupled telephone is on-hooked, the connector (62) is released, whereas the telephone network connector (63) is driven. While a connection of the sound input/output path is changed to the PSTN telephone from the directly coupled telephone, if the controller (28) sends the stored number through the line adapter controller (29), the DTMF transceiver (61) delivers the number to the PSTN as a DTMF signal to connect the call. Accordingly, it is possible to deliver a conversation to the general telephone while calling with the directly coupled telephone.

If a call completion signal is detected from either the receiving side or the sender side in speech state, the call is finished by the (P3)(P4) processes of FIG. 14c.

When the standby time for the call waiting state is elapsed (P2 process, FIG. 14b), all the ringing procedures of the PC and the directly coupled telephone are interrupted, and like the PSTN mode setup (P1 process, FIG. 14b), the PSTN telephone is connected.

So far, the process of variously receiving the paging signal in the general telephone or the directly coupled telephone by using PCs and each line adapter individually connected to the PCs has been described.

However, in case of one-to-one fixed access calling method for using the existing individual line adapters without employing collective gateways, a busy state does not occur. Nevertheless, since the present invention is equipped with a separate call processing server for collectively receiving/sending calls, a busy state may occur when the customer calls the provider. To solve this problem, like shown in a P7 process of FIG. 14f, the controller (28) of the user agent (21) in accordance with the present invention delivers a busy signal to the call processing server (12) through the signal processor (24), if the PC is in reception state in spite of a paging signal being received. When the busy signal is received, the call processing server (12) delivers prestored busy announcement message, counts a record waiting time, and stores the sender's voice message. When the record waiting time is elapsed, the call processing server (12) delivers the stored voice message to the e-mail server (5) as e-mail.

When the provider (receiver) clicks the e-mail showing that the voice message is received, the controller (28) delivers contents of the voice message such that the provider can listen to the voice message through a headset/speaker.

Until now, the receiving process has been explained. Next, a sending process will be fully described as follows.

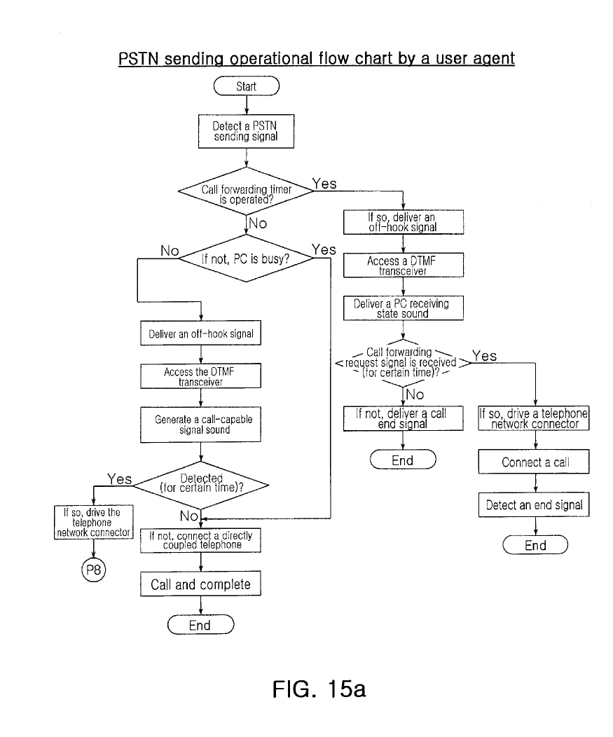

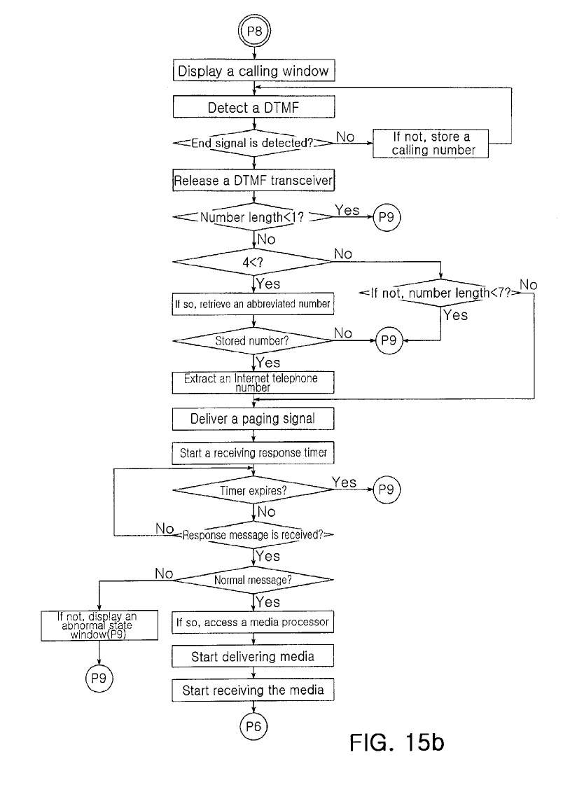

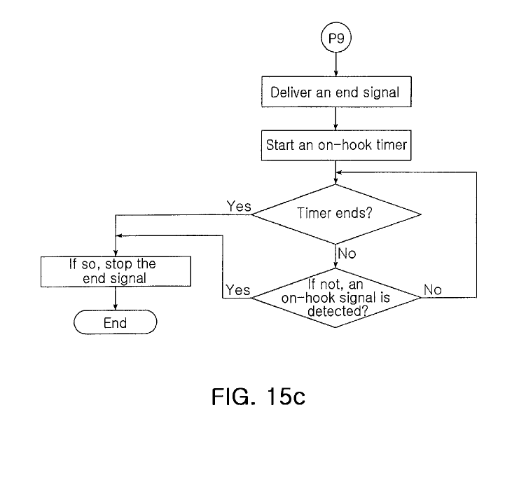

Referring to FIG. 15a, a case will be explained, with regards to making an Internet call in accordance with the present invention by using a general telephone connected to a PSTN by individually connecting each line adapter to a sender PC.

When a PSTN sending number is detected in the telephone network connector (63) through the line adapter controller (39), the user agent (31) of the sender (customer) PC first checks an operational state of a call transfer timer operating while a call is received in the PC. If the timer is being operated, the agent confirms whether the sender of PSTN intends to receive the call. Namely, the agent delivers a self off-hook signal to the telephone network connector (63) while connecting with the DTMF transceiver (61), to deliver a sound to alert that the PC is currently in interact call state. The agent waits for the intention of receiving the call (whether a call forwarding is requested), and if the intention is not received after a certain time elapses, a completion signal is delivered to complete the procedure. If the intention is received, the telephone network connector (63) is driven to connect the call, and the call is completed according to the completion signal.

At this time, if the PC is not in the receiving state, the agent checks whether the PC is in busy state. If so, the directly coupled telephone is linked to connect the call.

If it is not in the busy state, the telephone network connector (63) delivers an off-hook signal by the line adapter controller (39), and the DTMF transceiver (61) is connected to deliver a signal tone showing a transmissible state to the PC, then the first code (ex, ‘*’) of the Internet telephone is detected for a certain time. If the code is not detected within the certain time, the directly coupled telephone is connected like the case when the PC is in the busy state.

If the code is detected within the time, the telephone network connector (63) is driven, and like shown in a P8 process of FIG. 15b, a PC user input/output unit is driven to display a calling window through the PC user interface (35), and the inputted Internet telephone number of the PSTN telephone is detected and stored.

If a sending end code (ex, ‘#’) is detected, the controller (38) releases the DTMF transceiver (61), and analyzes an inputted calling number.

First, if a length of number is smaller than 1 (substantial number is 0), an end signal is delivered to the PSTN side, like shown in a P9 process of FIG. 15c, and it is checked whether the sender of the PSTN side puts down the telephone. If so, the delivery of the end signal is interrupted to complete the procedure.

If the inputted number corresponds to an abbreviated dial size (ex, if smaller than 4), the controller (38) retrieves stored abbreviated numbers to extract as an Internet telephone number for transmission. If the inputted number is bigger than the abbreviated dial size but smaller than the set Internet telephone number (ex, if smaller than 7), the number is handled by the 9P process of FIG. 15c. If the number corresponds to the Internet telephone number, the number is recognized as a telephone number, so that the signal processor (24) delivers a paging signal to the call processing server (12).

If a response signal is not received from a receiving side for a certain time, the paging signal is handled by the P9 process of FIG. 15c. And, if the response signal is received, the signal processor (24) checks whether the response signal refers to a normal message. If not, the response signal is handled by the P9 process of FIG. 15c. If the signal is normal, the media processor (33) is connected to start a media transmitting/receiving process while the call is completed according to the P6 process of FIG. 14d.

Like mentioned above, when plural receivers/senders make Internet calls in one system instead of one-to-one calls, the present invention supplies a function of receiving/sending the calls with the directly coupled telephone or the PSTN telephone by individually connecting each line adapter to each PC, in the user agent, thereby realizing user convenience.

That is, the present invention enables the PCs for conducting Internet calls and each line adapter individually connected to the PCs to carry out call receiving/sending functions, respectively. Furthermore, the present invention can offer essential functionality for the plural receivers and senders, by connecting the PCs with each line adapter when necessary while controlling them.

### EFFECT OF THE INVENTION

As stated above, the present invention enables the provider carrying on a business over the Internet to supply free calls through clicking functions on the provider's web page or e-mails to a great number of unspecified customers connected on the Internet, so that the provider can efficiently use the invention for advertising or business activities. And, the customers can also ask about or talk over necessary information or products free of charge in easy and convenient way. Besides, since icon-displayed provider information in accordance with the present invention is collected in a predetermined position such as a web server of a system operator and the collected information is provided to the customers, the provider can obtain an opportunity of showing the provider information to general customers who hardly connect to the provider web page, while the customers can simply select a desired provider by seeing, at a time, a lot of provider information related to desired fields by accessing a predetermined web server only, where information on the desired fields is collected, without a need to individually connect to web servers of hardly known providers to obtain the desired information, then the customers may easily make a free call with the selected provider. Furthermore, according to the present invention, a provider such as a trader who frequently makes calls with specific customers can provide a two-way call service to the customers free of charge without any procedures, thus the provider can conduct a two-way call with a desired party. In addition, because the present invention offers call statistical information on the customers to provide a closer service to the customers who call the provider with interest and to promote business activities, the provider can acquire business profits. As a result, the present invention ensures the above benefits for the provider who is the paid member or a two-way applicant, thereby promoting gains of the system operator who provides and operates the present system.

Moreover, it is easy to use since the users can receive/send calls with general telephones. And, a lot of other convenient functions including Call Pickup and Call Transfer are supplied for user convenience.

1-108. (canceled)

109. An Internet call controlling system using the Internet, comprising:
a DB server for storing information on registered members;
a web server of a provider for containing a click program that delivers unique information including an ID of the provider to a user agent having a sending function once an icon is clicked, and for including a web page on which the icon is displayed;
a customer PC for containing a user agent having a sending function of delivering the unique information, which includes the ID of the provider delivered by the click program, as a paging signal together with a customer ID, once the icon is clicked;
a call processing server configured to inquire about an IP address of a provider PC stored in the DB server, by receiving the paging signal;
the provider PC comprising a user agent having a receiving function of storing the customer ID by receiving the paging signal and connecting the call with the customer PC; and
an icon generator for extracting the provider's unique information from the DB server when the provider's member registration is authenticated, and automatically generating the click program,
wherein said provider and said customer are registered members of said DB server, said sending function of user agent of customer PC is functional when said customer PC is logged-in using information of said registered members, and said receiving function of user agent of provider PC is functional when said provider PC is logged-in using information of said registered members.

110. The Internet call controlling system of claim 109, wherein the provider's web server is equipped with the icon and the plural separate click programs associated with the icon, respectively.

111. The Internet call controlling system of claim 109, wherein the user agents of the customer PC and the provider PC are configured to include both receiving/sending functions, respectively.

112. The Internet call controlling system of claim 109, wherein the user agent having the sending function automatically registers the provider information delivered by the click program in a buddy list DB.

113. The Internet call controlling system of claim 109, wherein the user agent having the sending function adds an icon web page address registered by the provider to the provider information, and detects and compares a web page address (U.R.L) of the clicked icon, then stops the sending function if the web page address of the clicked icon is not identical to the web page address registered by the provider.

114. The Internet call controlling system of claim 109, wherein a service validity period of the provider is added to the provider information, and the user agent having the sending function compares the service validity period with the day appointed, and stops the sending function if the service validity period expires.

115. The Internet call controlling system of claim 109, wherein the click program is provided with a function of encoding and decoding the provider information.

116. The Internet call controlling system of claim 109, wherein the customer ID or the provider ID is an e-mail address of the customer or the provider, respectively.

117. The Internet call controlling system of claim 109, wherein a function of delivering a busy signal to the call processing server, if the provider PC is in busy state, is additionally provided, and the call processing server additionally consists of a busy message delivery function, a voice message recording function, and a delivery function for the recorded message with an e-mail.

118. An Internet call controlling system using the Internet, comprising:
a DB server for storing information on registered members;
a member management server having a click program which senses that an icon is clicked and delivers unique information of a provider to a user agent having a sending function;
an e-mail server for storing the provider's e-mail in which the icon is displayed;
a customer PC having a user agent that delivers the provider's unique information delivered by the click program, as a paging signal together with a customer ID, once the icon is clicked;
a call processing server configured to inquire about an IP address of a provider PC stored in the DB server, by receiving the paging signal;
the provider PC comprising a user agent having a receiving function of storing the customer ID by receiving the paging signal and connecting the call with the customer PC; and
an icon generator for extracting the provider's unique information from the DB server when the provider member registration is authenticated, and automatically generating the click program,
wherein said provider and said customer are registered members of said DB server, and said receiving function of user agent of provider PC is functional when said provider PC is logged-in using information of said registered members.

119. The Internet call controlling system of claim 118, wherein the user agents of the customer PC and the provider PC are configured to include both receiving/sending functions, respectively.

120. The Internet call controlling system of claim 118, wherein the user agent having the sending function automatically registers the provider information delivered by the click program in a buddy list DB.

121. The Internet call controlling system of claim 118, wherein the user agent having the sending function adds an icon web page address registered by the provider to the provider information, and detects and compares a web page address (U.R.L) of the clicked icon, then stops the sending function if the web page address of the clicked icon is not identical to the web page address registered by the provider.

122. The Internet call controlling system of claim 118, wherein a service validity period of the provider is added to the provider information, and the user agent having the sending function compares the validity period with the day appointed, and stops the sending function if the service validity period expires.

123. The Internet call controlling system of claim 118, wherein the click program is provided with a function of encoding and decoding the provider information.

124. The Internet call controlling system of claim 118, wherein the customer ID or the provider ID is an e-mail address of the customer or the provider, respectively.

125. The Internet call controlling system of claim 118, wherein a function of delivering a busy signal to the call processing server, if the provider PC is in busy state, is additionally provided, and the call processing server additionally consists of a busy message delivery function, a voice message recording function, and a delivery function for the recorded message with an e-mail.

126. An Internet call controlling system using the Internet, comprising:
a DB server for storing provider information;
a provider information processor for searching provider information corresponding to a search keyword inputted from a customer PC in the DB server, and providing the searched provider information to an icon generator for generating a click program which delivers unique information including IDs of each provider to a user agent having a sending function, once an icon associated with the unique information is clicked;
a member management server having the web server of a system operator, being equipped with the provider information and the click program in a predetermined location, by receiving the information and the program from the provider information processor and associating the received information and program with the icon, respectively;
a customer PC for containing a user agent having a sending function of delivering the provider's unique information delivered by the associated click program, as a paging signal together with a customer ID, once the icon is clicked;
a call processing server configured to inquire about an IP address of a provider PC stored in the DB server, by receiving the paging signal; and
the provider PC for containing a user agent having a receiving function of storing the customer ID by receiving the paging signal and connecting the call with the customer PC,
wherein said provider and said customer are registered members of said DB server, said sending function of user agent of customer PC is functional when said customer PC is logged-in using information of said registered members, and said receiving function of user agent of provider PC is functional when said provider PC is logged-in using information of said registered members.

127. The Internet call controlling system of claim 126, wherein the user agents of the customer PC and the provider PC are configured by including both receiving/sending functions, respectively.

128. The Internet call controlling system of claim 126, wherein the user agent having the sending function automatically registers the provider information delivered by the click program in a buddy list DB.

129. The Internet call controlling system of claim 126, wherein a service validity period of the provider is added to the provider information, and the user agent having the sending function compares the service validity period with the day appointed, and stops the sending function if the validity period expires.

130. The Internet call controlling system of claim 126, wherein the click program is provided with a function of encoding and decoding the provider information.

131. The Internet call controlling system of claim 126, wherein the customer ID or the provider ID is an e-mail address of the customer or the provider, respectively.

132. The Internet call controlling system of claim 126, wherein a function of delivering a busy signal to the call processing server, if the provider PC is in busy state, is additionally provided, and the call processing server additionally consists of a busy message delivery function, a voice message recording function, and a delivery function for the recorded message with an e-mail.

133. An Internet call controlling method using the Internet, comprising the steps of:
delivering information including the provider's ID by a click program when a customer clicks the icon displayed in the provider web server, the click program being included in a provider web server and associated with the clicked icon;
a user agent having a sending function, which is installed in a customer PC, receiving unique information including the provider's ID, and delivering the unique information as a paging signal together with a customer ID;
when the paging signal is received, inquiring about an IP address of a provider PC corresponding to the provider's ID included in the paging signal from a DB server where the provider's information is stored, by the call processing server, and delivering the paging signal together with the customer ID to the inquired IP address;
when the provider PC receives the paging signal, delivering a response message to the customer PC by a user agent having a receiving function; and
when the provider demands generation of a click program after being registered as a member in a member management server, an icon generator, extracting unique information containing the provider's ID stored in the DB server, and automatically generating the click program for delivering the unique information containing the provider's ID associated with an icon to a user agent having a sending function, once the icon is clicked,
wherein said provider and said customer are registered members of DB server, said sending function of user agent of customer PC is functional when said customer PC is logged-in using information of said registered members, and said receiving function of user agent of provider PC is functional when said provider PC is logged-in using information of said registered members.

134. The Internet call controlling method of claim 133, wherein an additional process is performed as follows: the provider copies the click program and puts the copied program in a predetermined position of a web page of the provider.

135. The Internet call controlling method of claim 133, wherein if the provider exists in plural, a process of individually generating the click program for each provider is carried out to separately put the generated plural click programs in web servers of the specific providers.

136. The Internet call controlling method of claim 133, wherein the user agents of the customer PC and the provider PC having the sending/receiving functions include both sending/receiving functions, respectively.

137. The Internet call controlling method of claim 133, wherein the user agent having the sending function has a process of automatically registering the provider information delivered by the click program in a buddy list DB.

138. The Internet call controlling method of claim 133, wherein a process is performed as follows: a web page address of the icon registered by the provider is added to the provider information, and the user agent having the sending function detects and compares a web page address (U.R.L) of the clicked icon and does not carry out the sending function if the web page address of the clicked icon is not identical to the web page address registered by the provider.

139. The Internet call controlling method of claim 133, wherein a process is performed as follows: a service validity period of the provider is added to the provider information, and the user agent having the sending function compares the service validity period with the day appointed and does not carry out the sending function if the service validity period expires.

140. The Internet call controlling method of claim 133, wherein the click program additionally has a provider information encoding and decoding function.

141. The Internet call controlling method of claim 133, wherein the customer ID or the provider ID is an e-mail address of the customer or the provider, respectively.

142. The Internet call controlling method of claim 133, wherein if a paging signal is additionally received in the provider PC which is in busy state, the receiving/sending user agents carry out a process of delivering a busy message, and the call processing server which has received the message delivers a busy announcement message and records a message of a PC of the sender to transmit the recorded message to a sender's e-mail server in the form of e-mail.

143. An Internet call controlling method using the Internet, comprising the steps of:
when a provider inputs the text of e-mail and a customer ID in a member management server and clicks a send button, an icon generator, extracting unique information containing the provider's ID from a DB server, and generating a click program for delivering the unique information containing the provider's ID associated with an icon to a user agent having a sending function, once the icon is clicked, then inserting the generated program into the e-mail to send the e-mail to a customer's e-mail server;
a customer PC, delivering the unique information including the provider's ID as a paging signal together with an ID of a customer PC by a user agent having a receiving function, when a displayed icon is clicked by receiving the e-mail from the e-mail server;
when the paging signal is received, inquiring about an IP address of a provider PC corresponding to the provider's ID included in the paging signal from the DB server where provider information is stored, by a call processing server, and delivering the paging signal together with the customer ID to the inquired IP address; and
when the provider PC receives the paging signal, delivering a response message to the customer PC by a user agent having a receiving function,
wherein said provider and said customer are registered members of said DB server, and said receiving function of user agent of provider PC is functional when said provider PC is logged-in using information of said registered members.

144. The Internet call controlling method of claim 143, wherein the user agents of the customer PC and the provider PC having the sending/receiving functions include both sending/receiving functions, respectively.

145. The Internet call controlling method of claim 143, wherein the user agent having the sending function has a process of automatically registering the provider information delivered by the click program in a buddy list DB.

146. The Internet call controlling method of claim 143, wherein a process is performed as follows: a service validity period of the provider is added to the provider information, and the user agent having the sending function compares the service validity period with the day appointed and does not carry out the sending function if the service validity period expires.

147. The Internet call controlling method of claim 143, wherein the click program additionally has a function of encoding and decoding the provider information.

148. The Internet call controlling method of claim 143, wherein the user agent having the receiving function has a process of automatically recording reception information including the received ID of the customer PC.

149. The Internet call controlling method of claim 143, wherein the customer ID or the provider ID is an e-mail address of the customer or the provider, respectively.

150. The Internet call controlling method of claim 143, wherein if a paging signal is additionally received in the provider PC which is in busy state, the receiving/sending user agents carry out a process of delivering a busy message, and the call processing server which has received the message delivers a busy announcement message and records a message of a PC of the sender to transmit the recorded message to a sender's e-mail server in the form of e-mail.

151. An Internet call controlling method using the Internet, comprising the steps of:
if a customer clicks a particular one of plural icons displayed in a web server of a system operator, decoding encoded information including a provider ID by a click program which is included in the web server of the system operator and associated with the clicked icon;
a user agent having a sending function, which is installed in the customer PC, receiving the provider information, and delivering a paging signal together with a customer ID;
when the paging signal is received, inquiring about an IP address of a provider PC corresponding to the provider's ID included in the paging signal from a DB server where the provider information is stored, by the call processing server, and delivering the paging signal together with the customer ID to the inquired IP address;
when the provider PC receives the paging signal, delivering a response message to the customer PC by a user agent having a receiving function; and
when the provider is registered as a member, an icon generator, extracting unique information including the provider's ID stored in the DB server, and automatically generating a click program for delivering the unique information including the provider's ID associated with an icon to the user agent, once the icon is clicked, then displaying the icon on a web page of the system operator,
wherein said provider and said customer are registered members of said DB server, said sending function of user agent of customer PC is functional when said customer PC is logged-in using information of said registered members, and said receiving function of user agent of provider PC is functional when said provider PC is logged-in using information of said registered members.

152. The Internet call controlling method of claim 151, wherein the user agents of the customer PC and the provider PC having the sending/receiving functions include both sending/receiving functions, respectively.

153. The Internet call controlling method of claim 151, wherein the user agent having the sending function has a process of automatically registering the provider information delivered by the click program in a buddy list DB.

154. The Internet call controlling method of claim 151, wherein a process is performed as follows: a service validity period of the provider is added to the provider information, and the user agent having the sending function compares the service validity period with the day appointed and does not carry out the sending function if the service validity period expires.

155. The Internet call controlling method of claim 151, wherein the click program additionally has a provider information encoding and decoding function.

156. The Internet call controlling method of claim 151, wherein the customer ID or the provider ID is an e-mail address of the customer or the provider, respectively.

157. The Internet call controlling method of claim 151, wherein if a paging signal is additionally received in the provider PC which is in busy state, the receiving/sending user agents carry out a process of delivering a busy message, and the call processing server which has received the voice message delivers a busy announcement message and records a message of a PC of the sender to transmit the recorded message to a sender's e-mail server in the form of e-mail.
